(19) United States
(12) Patent Application Publication
(10) Pub. No.: US 2026/0079864 A1
(43) Pub. Date: Mar. 19, 2026

(54) ROUTING INPUTS ON XR WEARABLE DEVICES

(71) Applicant: Tomasz Zakrzewski, Lachen (CH)

(72) Inventor: Tomasz Zakrzewski, Lachen (CH)

(21) Appl. No.: 18/885,807

(22) Filed: Sep. 16, 2024

(51) Int. Cl. G06F 13/20; G06F 1/16

(52) U.S. Cl. CPC G06F 13/20; G06F 1/163; G06F 2213/40

(57) ABSTRACT

Systems, methods, and computer readable media for routing inputs on a extended reality (XR) wearable device where the methods performed on an apparatus of a system include receiving, at an input framework service, an input data registration request from a client component, the input data registration request comprising an indication of a callback component and an indication of input data having a type, and verifying, at the input framework service, the client component is authorized to access the input data having the type. The method may further include registering, at the input framework service, the callback component with an input service associated with the input data having the type, receiving, at the input service, input data having the type, and invoking, at the input service, the callback component.

### TECHNICAL FIELD

Examples of the present disclosure relate generally to routing inputs on extended reality (XR) wearable devices. More particularly, but not by way of limitation, examples of the present disclosure relate to centralized routing of input data from input output (IO) devices to components of the XR wearable device where the structure of the input data is available to the components before accessing the input data and where the input data can be secured from access by other components of the XR wearable device.

### BACKGROUND

Users of XR wearable devices enjoy the services provided by applications that read and write data to IO devices. The volume of input data and number of IO devices continues to increase as more services are provided to the users. However, the XR wearable devices controlling and communicating with the IO devices may consume higher amounts of power, and due to the large number of IO devices, developing applications on the XR wearable devices may be difficult and may create security risks.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates a system in which the head-wearable apparatus, according to some examples.

FIG. 6 is a diagrammatic representation of a machine in the form of a computer system within which a set of instructions may be executed to cause the machine to perform any one or more of the methodologies discussed herein, according to some examples.

FIG. 7 is a block diagram showing a software architecture within which examples may be implemented.

FIG. 8 is a perspective view of a head-wearable apparatus in the form of glasses, in accordance with some examples.

FIG. 9 illustrates a system for routing inputs on an XR wearable device, in accordance with some examples.

FIG. 10 illustrates a system for processing inputs, in accordance with some examples.

FIG. 11 illustrates a system for routing inputs on an XR wearable device, in accordance with some examples.

FIG. 12 illustrates a system for routing inputs on an XR wearable device, in accordance with some examples.

FIG. 13 illustrates a system for routing inputs on an XR wearable device, in accordance with some examples.

FIG. 14 illustrates a system for routing inputs on an XR wearable device, in accordance with some examples.

FIG. 15 illustrates a system for routing inputs on an XR wearable device, in accordance with some examples.

FIG. 16 illustrates a system for routing inputs on an XR wearable device, in accordance with some examples.

FIG. 17 illustrates a system for routing inputs on an XR wearable device, in accordance with some examples.

FIG. 18 illustrates a method for routing inputs on an XR wearable device, in accordance with some examples.

FIG. 19 illustrates a method for routing inputs on an XR wearable device, in accordance with some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Users of battery-constrained wearable devices enjoy the services provided by applications or components that consume input data from IO devices. For example, a movie playing application on an augmented reality (AR), extended reality (XR), or virtual reality (VR) head-wearable device (“XR wearable device”) can provide entertainment to a user by making available many movies stored on a server. In another example, the XR wearable device provides XR images to supplement objects in the real-world such as providing an XR writing pen for a user of the XR wearable device to use to provide input to an application on the XR wearable device.

A technical problem is how to provide access to the input data of IO devices to applications or components on the XR wearable devices where the input data is available to multiple applications without introducing a delay in providing the input data. In some examples, the technical problem is solved by providing a centralized input framework service where an application requests access to input data. The input framework service determines whether the application has permissions to access the input data. The input framework service then registers a callback routine for the application with an input service component that manages the input data for that IO device. Additional applications can request access to the input data. The input service component for the input data calls the callback routine for each of the applications that are registered to receive the input data. The input data can be copied to the applications by the callback routines, or the input data can be accessed by providing a pointer to a buffer in memory storing the input data. An application program interface (API) is provided that indicates the format of the input data, the format of the callback routine, and the format of a request to receive the input data.

An additional technical problem is how to provide security to prevent an application from reading the input data when the application is not authorized to read the input data. For example, several applications may be actively receiving the input data from a keyboard, but one application needs to request a password from a user to logon to a secure account. The keyboard input needs to be restricted to only the application that needs to request a password. The technical problem is solved by the input framework service maintaining an active list of subscriptions to input data by applications. The application that needs exclusive access to input data sends a message to the input framework service requesting exclusive access to the input data. The input framework service then revokes or suspends the access to the input data from other applications.

Additionally, in some examples, the input service component for the input data of an IO device copies the input data into a separate buffer for each of the applications accessing the input data. Each of the applications are then given pointers to the location of their respective buffer. When an application loses access to input data that is being copied into each of the separate buffers, the system stops copying the input data to the buffer of the application that lost access to the input data. This prevents the applications from corrupting the input data of other applications. In some examples, when an application is paused, a privileged component of the XR wearable device suspends the application from being able to access the input data and indicates to the input service component for the input data that the application is paused. The input service component may buffer or discard the input data for the paused application.

### Networked Computing Environment

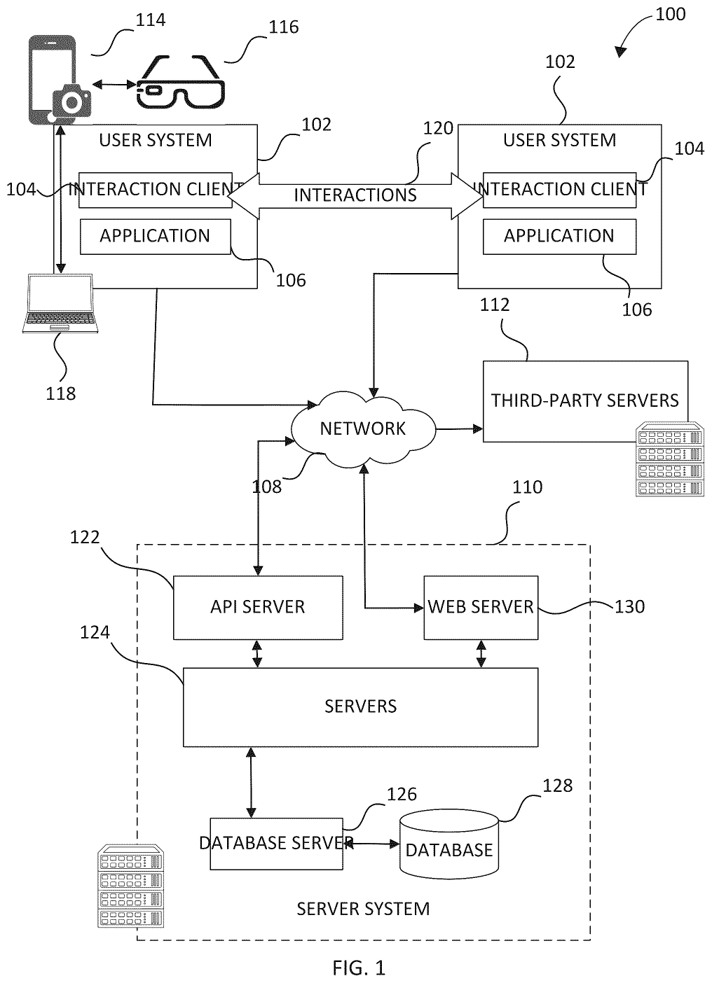

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

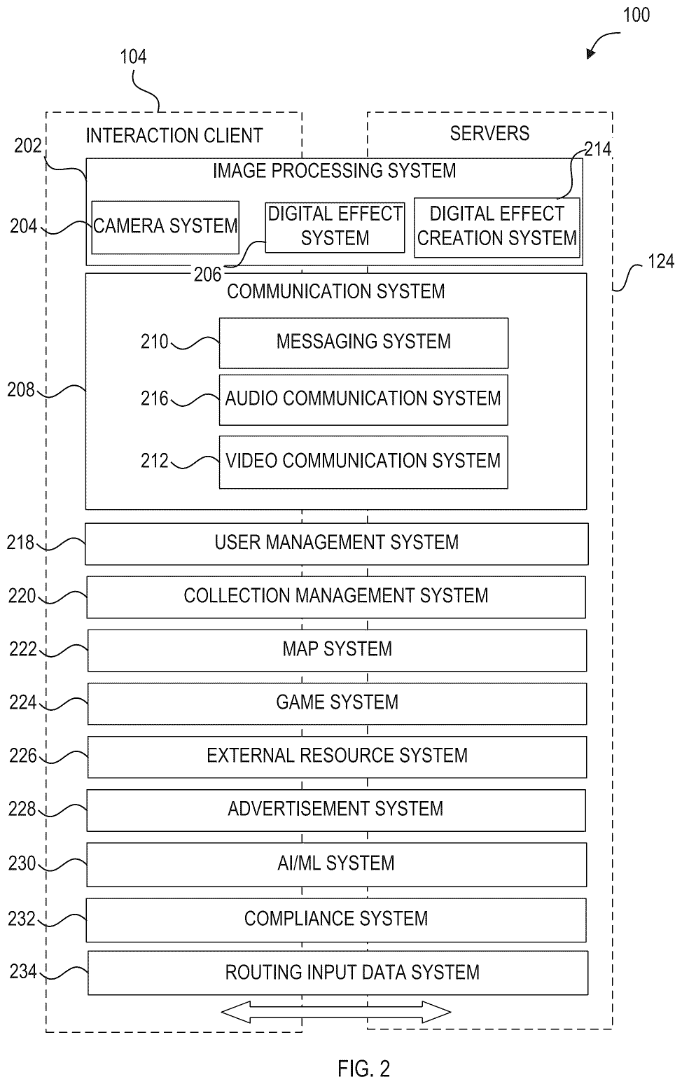

The servers 124 host multiple systems and subsystems, described below with reference to FIG. 2.

### External Recourses and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

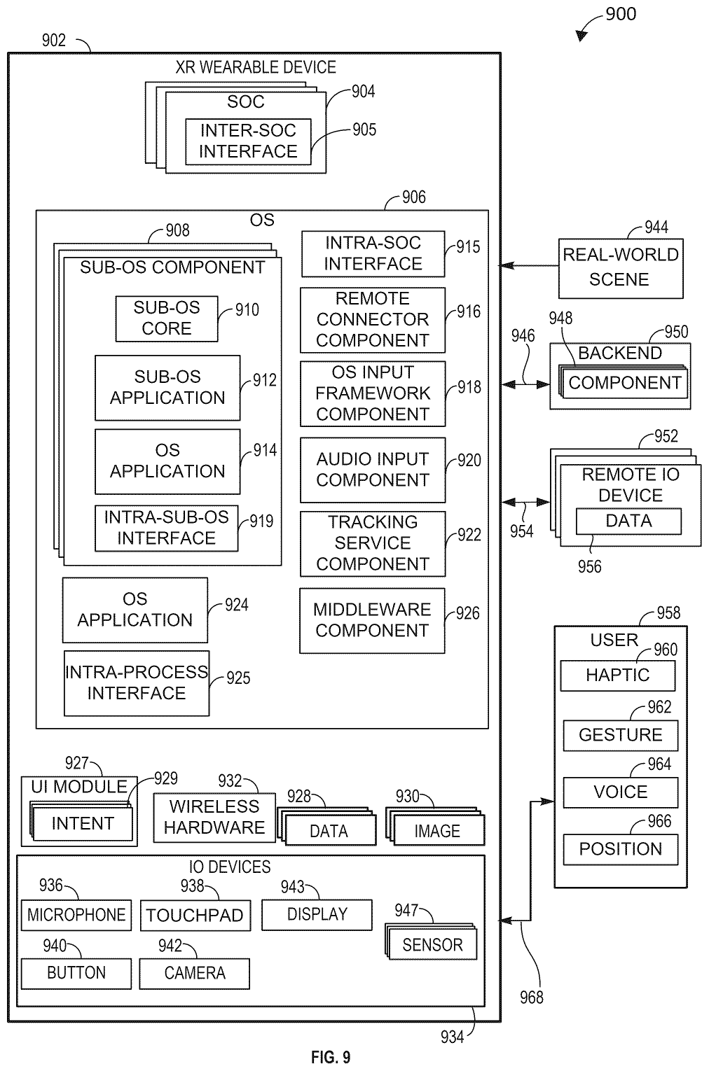

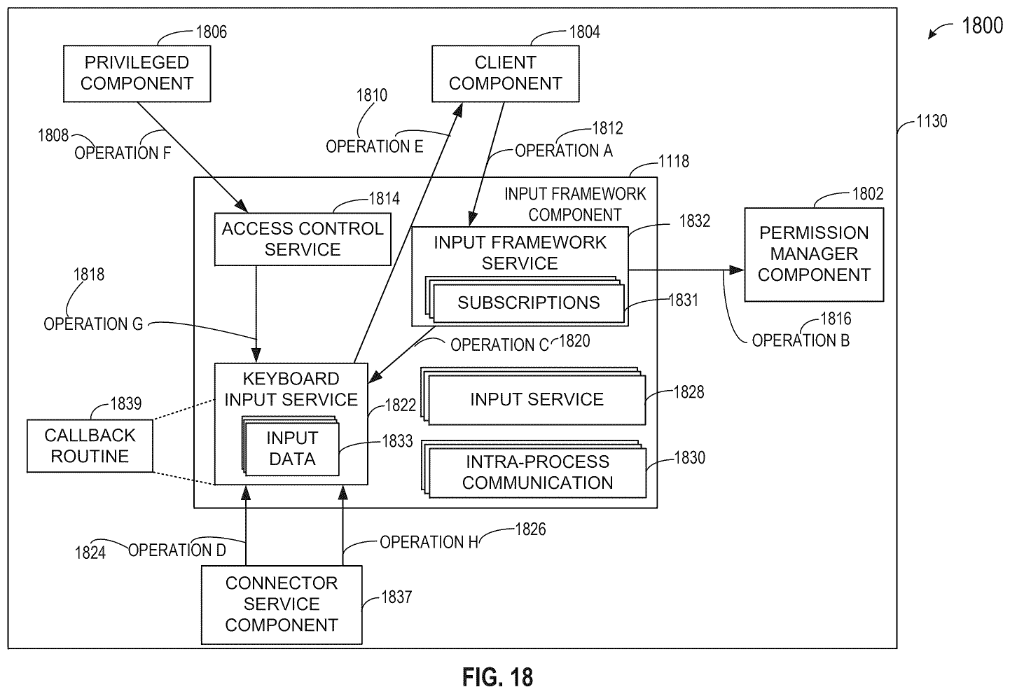

The routing input data system 234 provides various functions to the XR wearable device 902 of FIG. 9 to facilitate routing input data. In some examples, referring to FIG. 18, the routing input data system 234 responds to messages regarding permissions for input data 1833 from the input framework service 1832. In some examples, the routing input data system 234 provides the input data 1833 such as from a streaming service to the connector service component 1837. In some examples, the routing input data system 234 provides modules or code for the XR wearable device 902 to perform routing of the input data.

An image processing system 202 provides various functions that enable a user to capture and modify (e.g., augment, annotate or otherwise edit) media content associated with a message.

A camera system 204 includes control software (e.g., in a camera application) that interacts with and controls hardware camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 502 of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

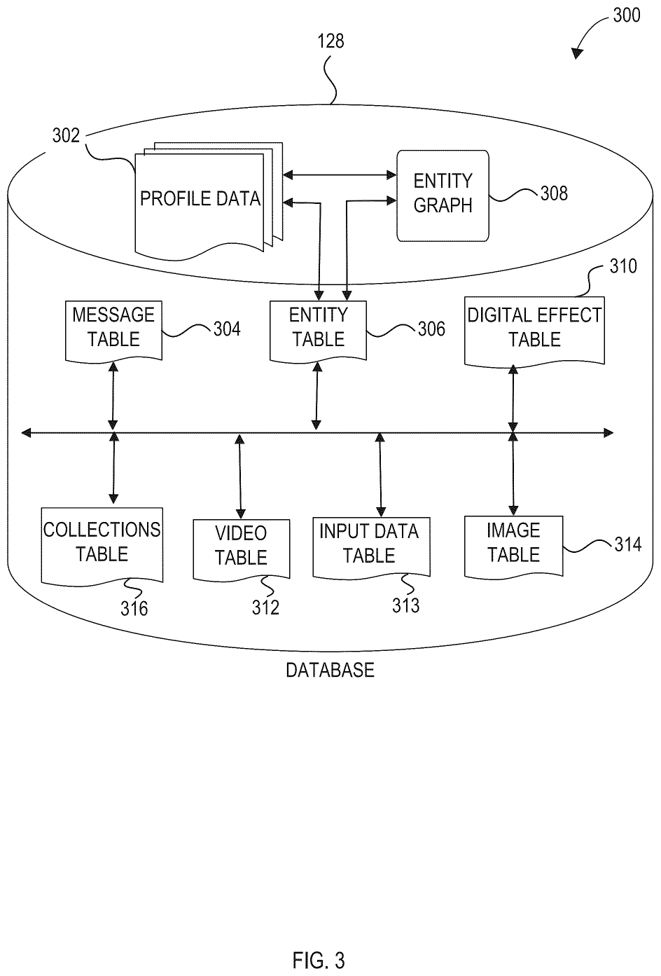

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 includes an input data table 313, which includes support information for the XR wearable device 902. The input data table 313 includes data associated with, referring to FIG. 18, permissions for the permission manager component 1802. The input data table 313 may also include input data 1833 that is streamed to the XR wearable device 902.

### Data Communications Architecture

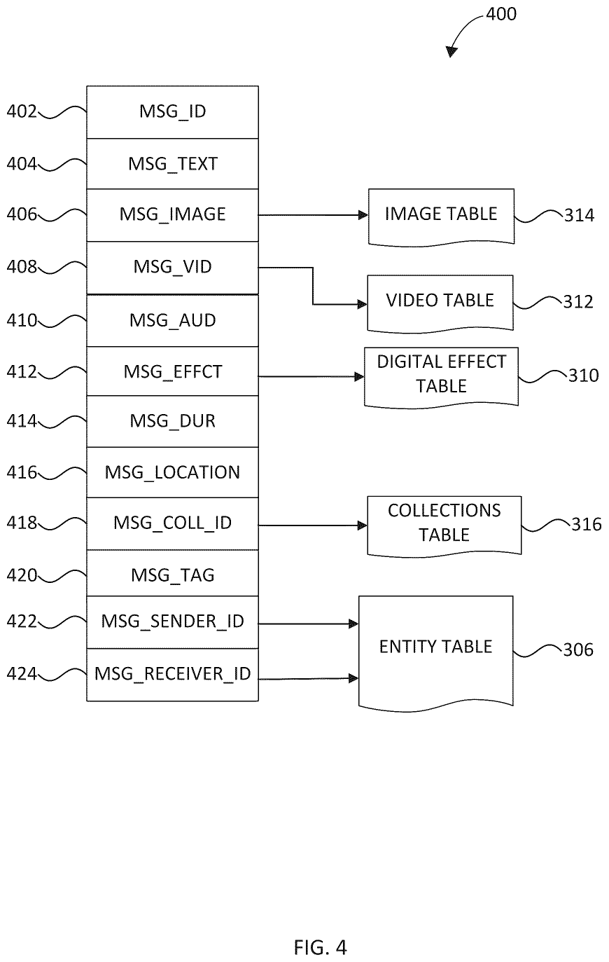

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier (MSG_ID 402): a unique identifier that identifies the message 400.
Message text (MSG_TXT 404) payload: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter (MSG_DUR 414): parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 314, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

System with Head-Wearable Apparatus

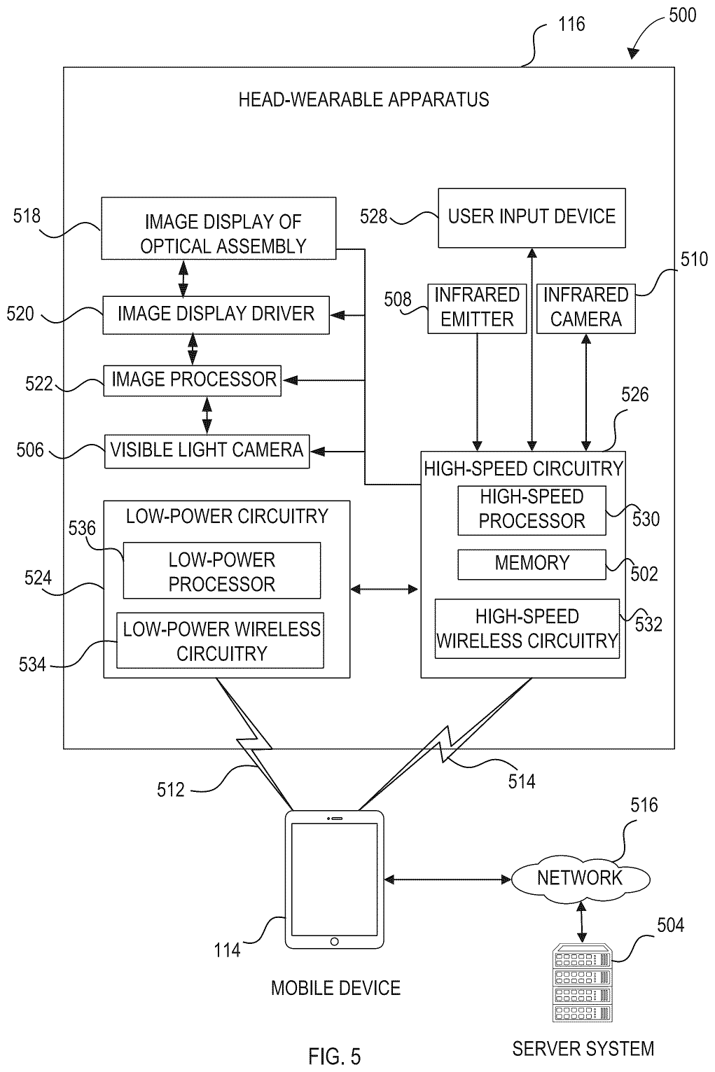

FIG. 5 illustrates a system 500 including a head-wearable apparatus 116 with a selector input device, according to some examples. FIG. 5 is a high-level functional block diagram of an example head-wearable apparatus 116 communicatively coupled to a mobile device 114 and various server systems 504 (e.g., the server system 110) via various networks 108.

The head-wearable apparatus 116 includes one or more cameras, each of which may be, for example, a visible light camera 506, an infrared emitter 508, and an infrared camera 510.

The mobile device 114 connects with head-wearable apparatus 116 using both a low-power wireless connection 512 and a high-speed wireless connection 514. The mobile device 114 is also connected to the server system 504 and the network 516.

The head-wearable apparatus 116 further includes two image displays of the image display of optical assembly 518. The two image displays of optical assembly 518 include one associated with the left lateral side and one associated with the right lateral side of the head-wearable apparatus 116. The head-wearable apparatus 116 also includes an image display driver 520, an image processor 522, low-power circuitry 524, and high-speed circuitry 526. The image display of optical assembly 518 is for presenting images and videos, including an image that can include a graphical user interface to a user of the head-wearable apparatus 116.

The image display driver 520 commands and controls the image display of optical assembly 518. The image display driver 520 may deliver image data directly to the image display of optical assembly 518 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 528 (e.g., touch sensor or push button), including an input surface on the head-wearable apparatus 116. The user input device 528 (e.g., touch sensor or push button) is to receive from the user an input selection to manipulate the graphical user interface of the presented image.

The components shown in FIG. 5 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 506 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 502, which stores instructions to perform a subset, or all the functions described herein. The memory 502 can also include storage device.

As shown in FIG. 5, the high-speed circuitry 526 includes a high-speed processor 530, a memory 502, and high-speed wireless circuitry 532. In some examples, the image display driver 520 is coupled to the high-speed circuitry 526 and operated by the high-speed processor 530 to drive the left and right image displays of the image display of optical assembly 518. The high-speed processor 530 may be any processor capable of managing high-speed communications and operation of any general computing system needed for the head-wearable apparatus 116. The high-speed processor 530 includes processing resources needed for managing high-speed data transfers on a high-speed wireless connection 514 to a wireless local area network (WLAN) using the high-speed wireless circuitry 532. In certain examples, the high-speed processor 530 executes an operating system such as a LINUX operating system or other such operating system of the head-wearable apparatus 116, and the operating system is stored in the memory 502 for execution. In addition to any other responsibilities, the high-speed processor 530 executing a software architecture for the head-wearable apparatus 116 is used to manage data transfers with high-speed wireless circuitry 532. In certain examples, the high-speed wireless circuitry 532 is configured to implement Institute of Electrical and Electronic Engineers (IEEE) 802.11 communication standards, also referred to herein as WI-FI®. In some examples, other high-speed communications standards may be implemented by the high-speed wireless circuitry 532.

The low-power wireless circuitry 534 and the high-speed wireless circuitry 532 of the head-wearable apparatus 116 can include short-range transceivers (e.g., Bluetooth™, Bluetooth LE, Zigbee, ANT+) and wireless wide, local, or wide area network transceivers (e.g., cellular or WI-FIR). Mobile device 114, including the transceivers communicating via the low-power wireless connection 512 and the high-speed wireless connection 514, may be implemented using details of the architecture of the head-wearable apparatus 116, as can other elements of the network 516.

The memory 502 includes any storage device capable of storing various data and applications, including, among other things, camera data generated by the left and right visible light cameras 506, the infrared camera 510, and the image processor 522, as well as images generated for display by the image display driver 520 on the image displays of the image display of optical assembly 518. While the memory 502 is shown as integrated with high-speed circuitry 526, in some examples, the memory 502 may be an independent standalone element of the head-wearable apparatus 116. In certain such examples, electrical routing lines may provide a connection through a chip that includes the high-speed processor 530 from the image processor 522 or the low-power processor 536 to the memory 502. In some examples, the high-speed processor 530 may manage addressing of the memory 502 such that the low-power processor 536 will boot the high-speed processor 530 any time that a read or write operation involving memory 502 is needed.

As shown in FIG. 5, the low-power processor 536 or high-speed processor 530 of the head-wearable apparatus 116 can be coupled to the camera (visible light camera 506, infrared emitter 508, or infrared camera 510), the image display driver 520, the user input device 528 (e.g., touch sensor or push button), and the memory 502.

The head-wearable apparatus 116 is connected to a host computer. For example, the head-wearable apparatus 116 is paired with the mobile device 114 via the high-speed wireless connection 514 or connected to the server system 504 via the network 516. The server system 504 may be one or more computing devices as part of a service or network computing system, for example, that includes a processor, a memory, and network communication interface to communicate over the network 516 with the mobile device 114 and the head-wearable apparatus 116.

The mobile device 114 includes a processor and a network communication interface coupled to the processor. The network communication interface allows for communication over the network 516, low-power wireless connection 512, or high-speed wireless connection 514. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 520. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 504, such as the user input device 528, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any I/O components including output components, motion components, position components, or any other such elements described herein.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 512 and high-speed wireless connection 514 from the mobile device 114 via the low-power wireless circuitry 534 or high-speed wireless circuitry 532.

### Machine Architecture

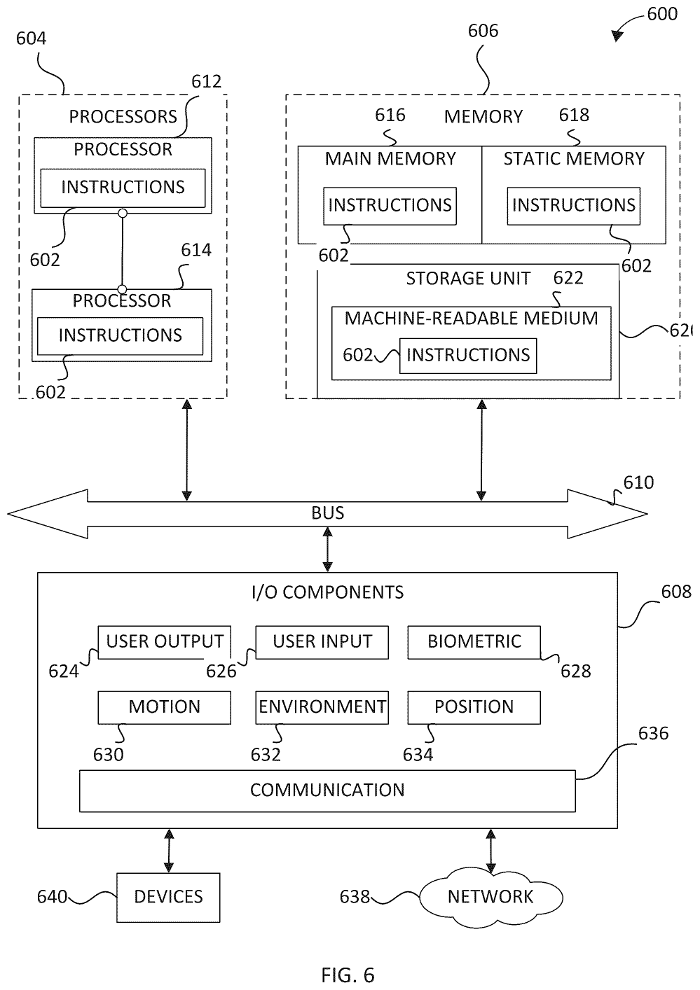

FIG. 6 is a diagrammatic representation of the machine 600 within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more of the methods described herein. The instructions 602 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term “machine” shall also be taken to include a collection of machines that individually or jointly execute the instructions 602 to perform any one or more of the methodologies discussed herein. The machine 600, for example, may comprise the user system 102 or any one of multiple server devices forming part of the server system 110. In some examples, the machine 600 may also comprise both client and server systems, with certain operations of a particular method or algorithm being performed on the server-side and with certain operations of the method or algorithm being performed on the client-side.

The machine 600 may include processors 604, 612, 614, memory 606, and input/output I/O components 608, which may be configured to communicate with each other via a bus 610.

The memory 606 includes a main memory 616, a static memory 618, and a storage unit 620, both accessible to the processors 604 via the bus 610. The main memory 606, the static memory 618, and storage unit 620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In some examples, the head-wearable apparatus 116 may include biometric 628 components or sensors to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information. The position 634 component may determine a position of the machine 600. Methods and apparatuses are described herein that determine position 634.

The motion components 630 include acceleration sensor components (e.g., accelerometer), gravitation sensor components, rotation sensor components (e.g., gyroscope).

The environmental components 632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 608 further include communication components 636 operable to couple the machine 600 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a USB).

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via Wi-Fi® signal triangulation, location via detecting an NFC beacon signal that may indicate a particular location, and so forth.

The various memories (e.g., main memory 616, static memory 618, and memory of the processors 604) and storage unit 620 may store one or more sets of instructions and data structures (e.g., software) embodying or used by any one or more of the methodologies or functions described herein. These instructions (e.g., the instructions 602), when executed by processors 604, cause various operations to implement the disclosed examples.

The instructions 602 may be transmitted or received over the network 638, using a transmission medium, via a network interface device (e.g., a network interface component included in the communication components 636) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 640.

### Software Architecture

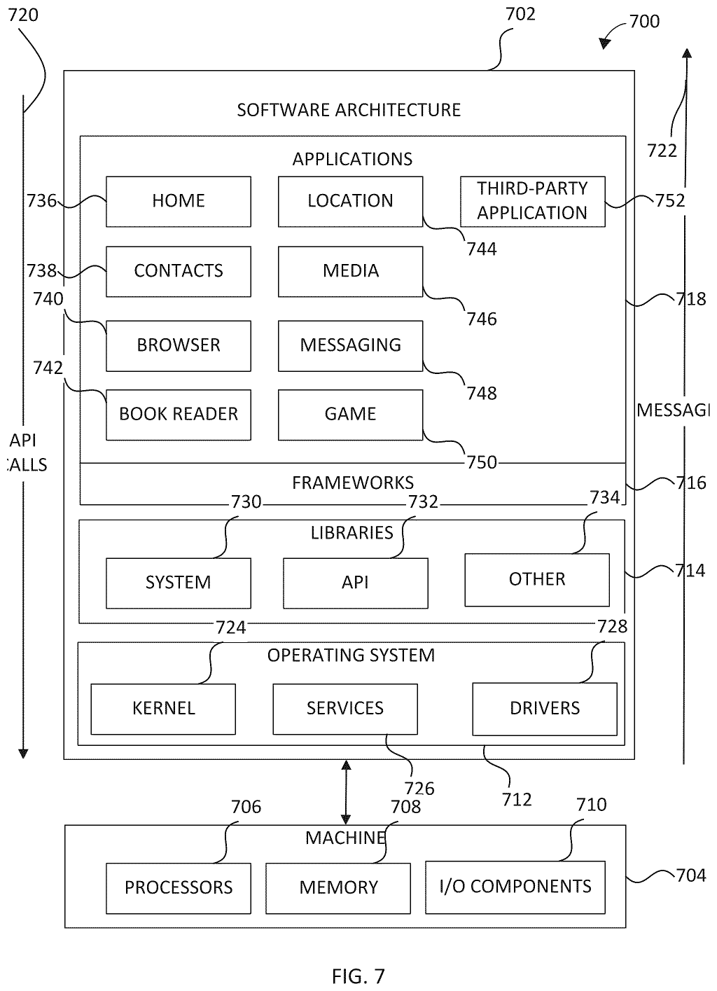

FIG. 7 is a block diagram 700 illustrating a software architecture 702, which can be installed on any one or more of the devices described herein. The software architecture 702 is supported by hardware such as a machine 704 that includes processors 706, memory 708, and I/O components 710. In this example, the software architecture 702 can be conceptualized as a stack of layers, where each layer provides a particular functionality. The software architecture 702 includes layers such as an operating system 712, libraries 714, frameworks 716, and applications 718. Operationally, the applications 718 invoke API calls 720 through the software stack and receive messages 722 in response to the API calls 720.

The operating system 712 manages hardware resources and provides common services. The operating system 712 includes, for example, a kernel 724, services 726, and drivers 728. The kernel 724 acts as an abstraction layer between the hardware and the other software layers. For example, the kernel 724 provides memory management, processor management (e.g., scheduling), component management, networking, and security settings, among other functionalities. The services 726 can provide other common services for the other software layers. The drivers 728 are responsible for controlling or interfacing with the underlying hardware. For instance, the drivers 728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 714 provide a common low-level infrastructure used by the applications 718. The libraries 714 can include system libraries 730 (e.g., C standard library) that provide functions such as memory allocation functions, string manipulation functions, mathematical functions, and the like. In addition, the libraries 714 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 714 can also include a wide variety of other libraries 734 to provide many other APIs to the applications 718.

The frameworks 716 provide a common high-level infrastructure that is used by the applications 718. For example, the frameworks 716 provide various graphical user interface (GUI) functions, high-level resource management, and high-level location services. The frameworks 716 can provide a broad spectrum of other APIs that can be used by the applications 718, some of which may be specific to a particular operating system or platform.

In an example, the applications 718 may include a home application 736, a contacts application 738, a browser application 740, a book reader application 742, a location application 744, a media application 746, a messaging application 748, a game application 750, and a broad assortment of other applications such as a third-party application 752. The applications 718 are programs that execute functions defined in the programs. Various programming languages can be employed to create one or more of the applications 718, structured in a variety of manners, such as object-oriented programming languages (e.g., Objective-C, Java, or C++) or procedural programming languages (e.g., C or assembly language). In a specific example, the third-party application 752 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 752 can invoke the API calls 720 provided by the operating system 712 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

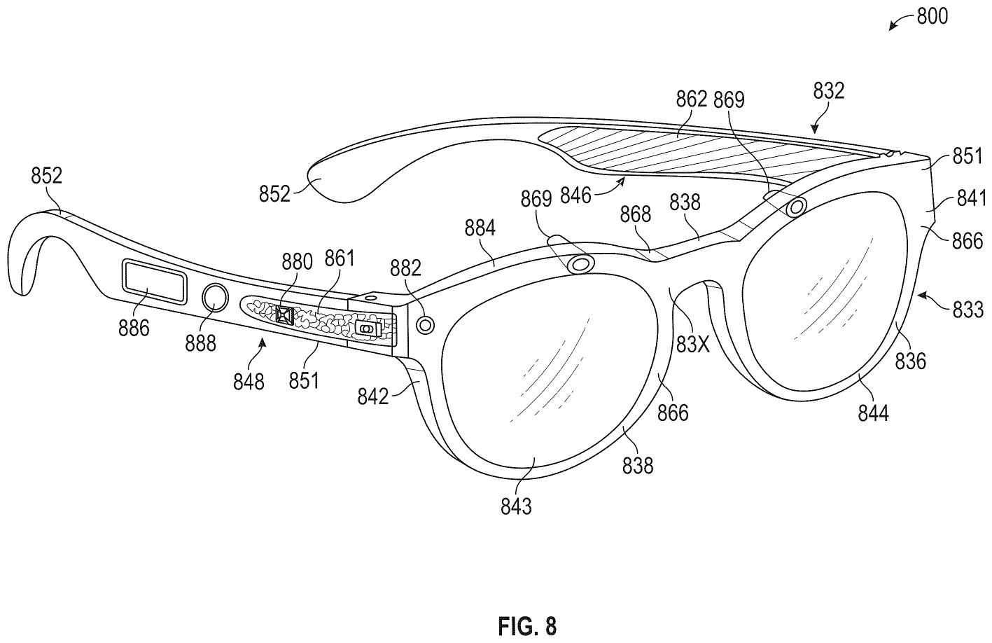

FIG. 8 is a perspective view of a head-wearable apparatus in the form of glasses 800, in accordance with some examples. The glasses 800 are an article of eyewear including electronics, which operate within a network system for communicating image and video content. FIG. 8 illustrates an example of the head-wearable apparatus 116. In some examples, the wearable electronic device is termed augmented reality (AR), mixed reality (MR), virtual reality (VR), and/or extended reality (XR) glasses. The glasses 800 can include a frame 832 made from any suitable material such as plastic or metal, including any suitable shape memory alloy. The frame 832 can have a front piece 833 that can include a first or left lens, display, or optical element holder 836 and a second or right lens, display, or optical element holder 837 connected by a bridge 838. The front piece 833 additionally includes a left end portion 841 and a right end portion 842. A first or left optical element 844 and a second or right optical element 843 can be provided within respective left and right optical element holders 836, 837. Each of the optical elements 843, 844 can be a lens, a display, a display assembly, or a combination of the foregoing. In some examples, for example, the glasses 800 are provided with an integrated near-eye display mechanism that enables, for example, display to the user of preview images for visual media captured by cameras 869 of the glasses 800.

The frame 832 additionally includes a left arm or temple piece 846 and a right arm or temple piece 847 coupled to the respective left and right end portions 841, 842 of the front piece 833 by any suitable means such as a hinge (not shown), so as to be coupled to the front piece 833, or rigidly or fixedly secured to the front piece 833 so as to be integral with the front piece 833. Each of the temple pieces 846 and 847 can include a first portion 851 that is coupled to the respective end portion 841 or 842 of the front piece 833 and any suitable second portion 852, such as a curved or arcuate piece, for coupling to the car of the user. In one example, the front piece 833 can be formed from a single piece of material, so as to have a unitary or integral construction. In one example, the entire frame 832 can be formed from a single piece of material so as to have a unitary or integral construction.

The glasses 800 include a computing device, such as a computer 861, which can be of any suitable type so as to be carried by the frame 832 and, in one example, of a suitable size and shape, so as to be at least partially disposed in one or more of the temple pieces 846 and 847. In one example, the computer 861 has a size and shape similar to the size and shape of one of the temple pieces 846, 847 and is thus disposed almost entirely if not entirely within the structure and confines of such temple pieces 846 and 847.

In one example, the computer 861 can be disposed in both of the temple pieces 846, 847. The computer 861 can include one or more processors with memory, wireless communication circuitry, and a power source. The computer 861 comprises low-power circuitry, high-speed circuitry, location circuitry, and a display processor. Various other examples may include these elements in different configurations or integrated together in different ways. Additional details of aspects of the computer 861 may be implemented as described with reference to the description that follows.

The computer 861 additionally includes a battery 862 or other suitable portable power supply. In one example, the battery 862 is disposed in one of the temple pieces 846 or 847. In the glasses 800 shown in FIG. 8, the battery 862 is shown as being disposed in the left temple piece 846 and electrically coupled using a connection 874 to the remainder of the computer 861 disposed in the right temple piece 847. One or more input and output devices can include a connector or port (not shown) suitable for charging a battery 862 accessible from the outside of the frame 832, a wireless receiver, transmitter, or transceiver (not shown), or a combination of such devices.

The glasses 800 include digital cameras 869. Although two cameras 869 are depicted, other examples contemplate the use of a single or additional (i.e., more than two) cameras 869. For case of description, various features relating to the cameras 869 will be described further with reference to only a single camera 869, but it will be appreciated that these features can apply, in suitable examples, to both cameras 869. For example, the cameras 869 may include back facing cameras to capture the eyes of the user of the glasses 800.

In various examples, the glasses 800 may include any number of input sensors or peripheral devices in addition to the cameras 869. The front piece 833 is provided with an outward-facing, forward-facing, front, or outer surface 866 that faces forward or away from the user when the glasses 800 are mounted on the face of the user, and an opposite inward-facing, rearward-facing, rear, or inner surface 867 that faces the face of the user when the glasses 800 are mounted on the face of the user. Such sensors can include inward-facing video sensors or digital imaging components such as cameras 869 that can be mounted on or provided within the inner surface 867 of the front piece 833 or elsewhere on the frame 832 so as to be facing the user, and outward-facing video sensors or digital imaging components such as the cameras 869 that can be mounted on or provided with the outer surface 866 of the front piece 833 or elsewhere on the frame 832 so as to be facing away from the user. Such sensors, peripheral devices, or peripherals can additionally include biometric sensors, location sensors, accelerometers, or any other such sensors. In some examples, projectors (not illustrated) are used to project images on the inner surface of the optical elements 843, 844 (or lenses) to provide a mixed reality or augmented reality experience for the user of the glasses 800.

The glasses 800 further include an example of a camera control mechanism or user input mechanism comprising a camera control button mounted on the frame 832 for haptic or manual engagement by the user. The camera control button provides a bi-modal or single-action mechanism in that it is disposable by the user between only two conditions, namely an engaged condition and a disengaged condition. In this example, the camera control button is a push button that is by default in the disengaged condition, being depressible by the user to dispose it to the engaged condition. Upon release of the depressed camera control button, it automatically returns to the disengaged condition.

In other examples, the single-action input mechanism can instead be provided by, for example, a touch-sensitive button comprising a capacitive sensor mounted on the frame 832 adjacent to its surface for detecting the presence of a user's finger, to dispose the touch-sensitive button to the engaged condition when the user touches a finger to the corresponding spot on the outer surface 866 of the frame 832. It will be appreciated that the above-described camera control button and capacitive touch button are but two examples of a haptic input mechanism for single-action control of the camera 869, and that other examples may employ different single-action haptic control arrangements.

The computer 861 is configured to perform the methods described herein. In some examples, the computer 861 is coupled to one or more antennas for reception of signals from a GNSS and circuitry for processing the signals where the antennas and circuitry are housed in the glasses 800. In some examples, the computer 861 is coupled to one or more wireless antennas and circuitry for transmitting and receiving wireless signals where the antennas and circuitry are housed in the glasses 800. In some examples, there are multiple sets of antennas and circuitry housed in the glasses 800. In some examples, the antennas and circuitry are configured to operate in accordance with a communication protocol such as Bluetooth™, Low-energy Bluetooth™, IEEE 802, IEEE 802.11az/be, WiFI®, and so forth. In some examples, PDR sensors housed in glasses 800 and coupled to the computer 861. In some examples, the glasses 800 are VR headsets where optical elements 843, 844 are opaque screens for displaying images to a user of the VR headset. In some examples, the computer 861 is coupled to user interface elements such as slide or touchpad 876 and button 878. A long press of button 878 resets the glasses 800. The slide or touchpad 876 and button 878 are used for a user to provide input to the computer 861 and/or other electronic components of the glasses 800. The glasses 800 include one or more microphones 882 that are coupled to the computer 861. The glasses 800 include one or more gyroscopes 880.

### Routing Inputs on XR Wearable Devices

FIG. 9 illustrates a system 900 for routing inputs on an XR wearable device, in accordance with some examples. The system 900 includes an XR wearable device 902 such as glasses 800 of FIG. 8 or head-wearable apparatus 116 of FIGS. 1 and 5. The XR wearable device 902 may be an AR device, XR device, VR device, or another type of device, in accordance with some examples.

The system 900 includes XR wearable device 902, real-world scene 944, which is what the user 958 sees of the world, backend 950, remote input/output (IO) device 952, and user 958, which is the user 958 of the XR wearable device 902.

The IO devices 934 include devices that enable a user 958 to receive output or provide input 968 to the system 900. The IO devices 934 include a microphone 936, a touchpad 938, a display 943, a button 940, a camera 942, and sensors 947. The XR wearable device 902 may include other IO devices 934 not illustrated. The camera 942 or image capturing device captures images 930 of the real-world scene 944 and may capture images 930 of the user 958. There may be one or more of each of the IO devices 934. For example, there may be a camera 942 capturing the real-world scene 944 and a camera 942 capturing a face of the user 958. The user 958 may look through optical elements 843, 844 (or lenses) of FIG. 8 to see a user view of the real-world scene 944. The position 966 is a position of the user 958. In some examples, the position 966 is in 3D coordinates within a 3D world coordinate system that indicates a location of the user view within the real-world scene 944. Other IO device 934 and/or remote IO devices 952 can include other devices such as a virtual keyboard, joystick, game pad, and so forth. In some examples, the IO devices 934 include a physical keyboard connected via the wireless hardware 932. In some examples, the virtual keyboard is an XR keyboard, which is a graphical keyboard displayed to the user 958 on the display 943 and where the UI module 927 determines the intent 929 of the user 958 to select a key of the XR keyboard based on movements of the fingers or another appendage of the user 958.

The camera 942 may be charged-coupled device (CCD) or another type of device to capture an image of the real-world scene 944. An example of button 940 is button 878 of FIG. 8. An example of the touchpad 938 is touchpad 876. The button 940 and touchpad 938 enable the user 958 to provide haptic 960 input. In some examples, haptic 960 feedback or output is provided to the user 958. For example, a paired remote IO device 952 such as a mobile phone with sensors for six degrees of freedom may be used as a golf club for an application on the XR wearable device 902. When the user 958 hits a virtual golf ball with the virtual golf club haptic 960 output is provided to the user 958 by activating vibrators, which are haptic 960 output, on the mobile phone. The microphone 936 enables the user 958 to provide voice 964 input. The camera 942 enables the user 958 to provide gesture 962 input via the UI module 927, which processes or analyzes the images 930 or uses another module to process and analyze the images 930 to determine the gesture 962 and the user intent 929 based on the analysis of the images 930.

The sensors 947 includes a gyroscope, light sensor, a positioning sensor, a clock, and so forth. In some examples, the camera 942 is considered a sensor 947. An example gyroscope is gyroscopes 880 of FIG. 8. Some sensors 947 such as a gyroscope can be used by the user 958 for input. For example, the user 958 may move the XR wearable device 902, which changes the position 966 of the user 958 and communicates input to the XR wearable device 902. The position 966 of the user 958 is assumed to be the same as the XR wearable device 902, in accordance with some examples. The XR wearable device 902 detects the change in position 966 using a sensor 947 such as a gyroscope or another sensor to detect the change of position 966 of the user 958. The movement of the user 958 may have an intent 929 to communicate input to the XR wearable device 902. However, the user 958 may move with the XR wearable device 902 without an intent 929 to communicate input to the XR wearable device 902.

The remote IO device 952 is an IO device 934 that is not physically part of the XR wearable device 902. The remote IO device 952 generates data 956 that is transferred to the XR wearable device 902. A remote touchpad is an example remote IO device 952.

The wireless hardware 932 communicates 946 between the backend 950 and the XR wearable device 902 and communicates 954 between the XR wearable devices 902 and the remote IO device 952. The wireless hardware 932 is configured to perform wireless communication protocols with the backend 950 and the XR wearable devices 902. The communication protocols may include LE Bluetooth, Institute for Electrical and Electronic Engineers (IEEE) 802.11 communication protocols, proprietary communications protocols, 3GPP communication protocols, and so forth. The wireless hardware 932 sets up a wireless communication link between the XR wearable device 902 and the backend 950 and between the XR wearable device 902 and remote IO device 952. For example, the wireless hardware 932 associates with a corresponding wireless module on the backend 950. The wireless hardware 932 may communicate with the backend 950 or the remote IO device 952 via another intermediate device such as a user system 102, which may also be the backend 950, an access point, or a node B. The components 948 of the backend 950 provide services such as processing the images 930 for the tracking service component 922. The tracking service component 922 needs to process the images 930 in a timely fashion to avoid a perception of lag by the user 958. Approximately 16 ms is the threshold for when the user 958 perceives a lag when being presented images on the display 943. Additionally, with a 60 frames per second (fps) display 943, 16 ms is the duration the XR wearable device 902 has to process and present a frame on the display 943. An example function of an OS application 924 or sub-OS application 912 that needs to avoid a lag is a virtual pen which follows the hand of the user 958 and enables the user 958 to provide input data 928 to the XR wearable device 902. The OS application 924 or sub-OS application 912 needs to track the hand of the user 958 and present XR graphics of the virtual pen so the virtual pen appears to the user 958 to remain in the same position relative to the hand of the user 958 as the user 958 moves their hand.

The IO devices 934, wireless hardware 932, and remote IO devices 952 generate the data 928 and images 930. The UI module 927 determines an intent 929 of the user 958 based on the data 928, images 930, and processed data 928 and images 930 such as the output of the tracking service component 922.

The XR wearable device 902 may have one or more systems on a chip (SoC) 904. The various components may be separated and operate on different SoC 904 and/or some components may operate on multiple SoC 904 or move between SoC 904. The inter-SOC interface 905 is an interface where two or more SoC 904 exchange data. The operating system, OS 906, manages the resources of the XR wearable device 902. The OS 906 may reside on one or more of the SoC 904. In some examples, one or more SoC 904 may each have an OS 906.

The intra-SOC interface 915 is an interface where components that reside on a same SoC 904 exchange data. The sub-OS component 908 is a component that is run by the OS 906 or may run natively on the XR wearable device 902 and interacts with the OS 906. In some examples, the sub-OS component 908 is an interpreter that is run by the OS 906 or a native application that runs with the OS 906. The intra-sub-OS interface 919 is an interface where components that reside within the sub-OS component 908 exchange data.

The sub-OS core 910 is a kernel part of the SUB-OS component 908 and includes basic services provided by the sub-OS component 908. The sub-OS application 912 is an application written within the context of the sub-OS component 908. For example, the sub-OS application 912 is programming code, which may have been compiled, that is interpreted by the sub-OS component 908. The sub-OS application 912 may be written in Java®, Typescript, or Javascript®, in accordance with some examples. The OS application 914 and OS application 924 are applications written within the context of the OS 906. For example, the OS application 914 and OS application 924 are written to interface with the tracking service component 922 of the OS 906 and with the sub-OS core 910. In some examples, OS application 914 is an application to provide interfaces for the services offered by the OS 906 to the sub-OS component 908. In some examples, the OS applications 924 are written in languages such as C, C++, Kotlin®, Java®, Python®, Javascript®, and so forth.

The remote connector component 916 connects the remote IO device 952 via the wireless hardware 932. The OS input framework component 918 manages the data 928, images 930, and IO devices 934 for the OS 906. The audio input component 920 manages the data 928 from the microphone 936 and a speaker, in accordance with some examples.

The tracking service component 922 provides services to track the user 958 and other objects within the images 930. The middleware component 926 manages some data 928 and IO devices 934 and may determine the intent 929 of the user 958.

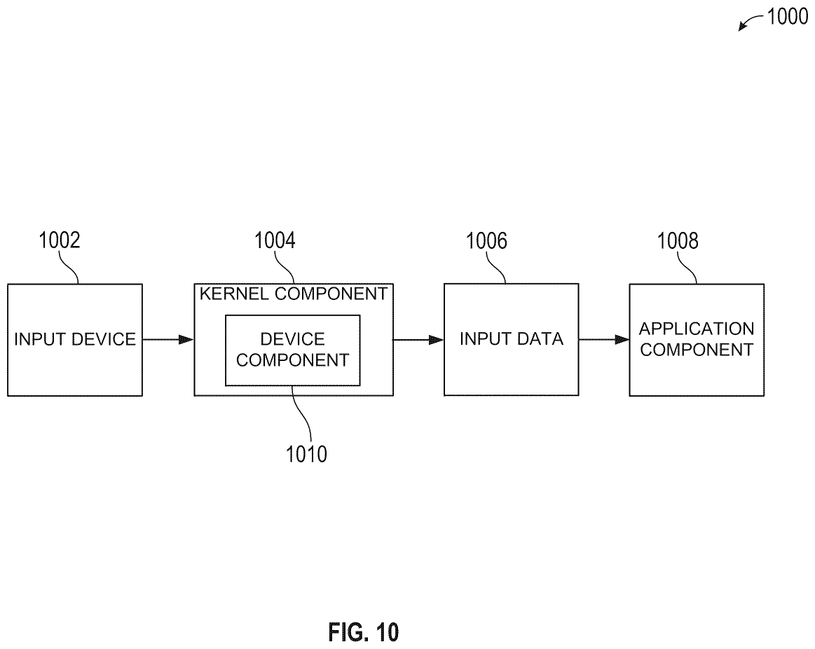

FIG. 10 illustrates a system 1000 for processing inputs, in accordance with some examples. The input device 1002 is managed by a device component 1010, which is part of the kernel component 1004 of an operating system. The input device 1002 generates data that is processed by the device component 1010 to generate the input data 1006. The input data 1006 is made available to the application component 1008. For example, the input data 1006 may be placed in a buffer and the application component 1008 may check the buffer for the input data 1006 or the device component 1010 may notify the application component 1008 when new input data 1006 is generated and send the input data 1006 to the application component 1008.

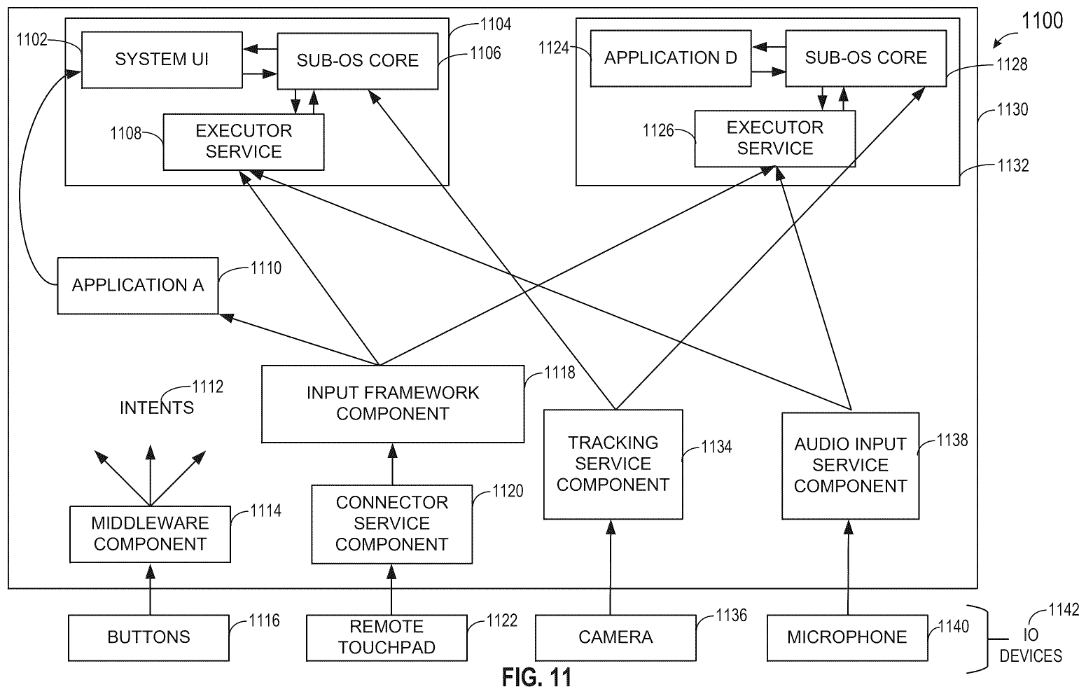

FIG. 11 illustrates a system 1100 for routing inputs on an XR wearable device, in accordance with some examples. The IO devices 1142 are the same or similar as IO devices 934 and remote IO devices 952 of FIG. 9, and include buttons 1116, remote touchpad 1122, camera 1136, and microphone 1140. The system 1100 illustrates the flow of data generated by the IO device 1142 to the components of the system 1100 that process and/or consume the data generated by the IO devices 1142. The microphone 1140 generates signals or data and the audio input service component 1138 manages the microphone 1140 and receives the generated data. The Audio input service component 1138 is part of the OS 1130, which is the same or similar as OS 906. The audio input service component 1138 provides the audio data to executor service 1126 and executor service 1108. Executor service 1126 is using the services of the OS 1130 while operating within sub-OS 1104, 1132, which are the same or similar as sub-OS components 908. Executor service 1108 and executor service 1126 are configured to interface with the OS 1130 and may receive input directly. The sub-OS core 1106 receives input via the executor service 1108, in accordance with some examples. The sub-OS core 1106 may then transfer the input data from the microphone 1140 to application D 1124. The sub-OS core 1128 may then indicate that input data is available from the microphone 1140 to the system UI 1102.

Tracking service component 1134 manages and receives images from the camera 1136. Tracking service component 1134 is the same or similar as tracking service component 922. Tracking service component 1134 sends the image data from the camera 1136 or notifies the sub-OS cores 1106, 1128 that the image data is available. In some examples, the tracking service component 1134 performs computer vision methods and/or neural network methods on the image data and generates higher-level inferred information such as hand tracking information, gesture recognition, image-based tracking, plane tracking, and so forth. The tracking service component 1134 makes this information available to the sub-OS cores 1106, 1128 and/or applications.

The sub-OS cores 1106, 1128 are the same or similar as sub-OS cores 910. Connector service component 1120 manages and receives data from the remote touchpad 1122. The connector service component 1120 is similar or the same as remote connector component 916. Connector service component 1120 sends the data from the remote touchpad 1122 to the input frame component 1118 or notifies the input framework component 1118 that the data from the remote touchpad 1122 is available.

The input framework component 1118 notifies or sends the remote touchpad 1122 data to application A 1100, executor service 1108, and executor service 1126. The input framework component 1118 is the same or similar as OS input framework component 918. The middleware component 1114 manages and receives data from buttons 1116. The middleware component 1114 may be the same or similar as middleware component 926. The middleware component 1114 determines intents 1112 of the user 958 of FIG. 9. The intents 1112 can be sent to one or more components of the OS 1130.

The application D 1124 receives input data from the sub-OS core 1128 or is notified of the availability of input data by the sub-OS core 1128. The application D 1124 may be the same or similar as sub-OS application 912. The system UI 1102 is a placeholder for application A 1110 when application A 1110 is paused. The system UI 1102 and application A 1110 receive input data from the sub-OS core 1128 or are notified of the availability of input data by the sub-OS core 1128.

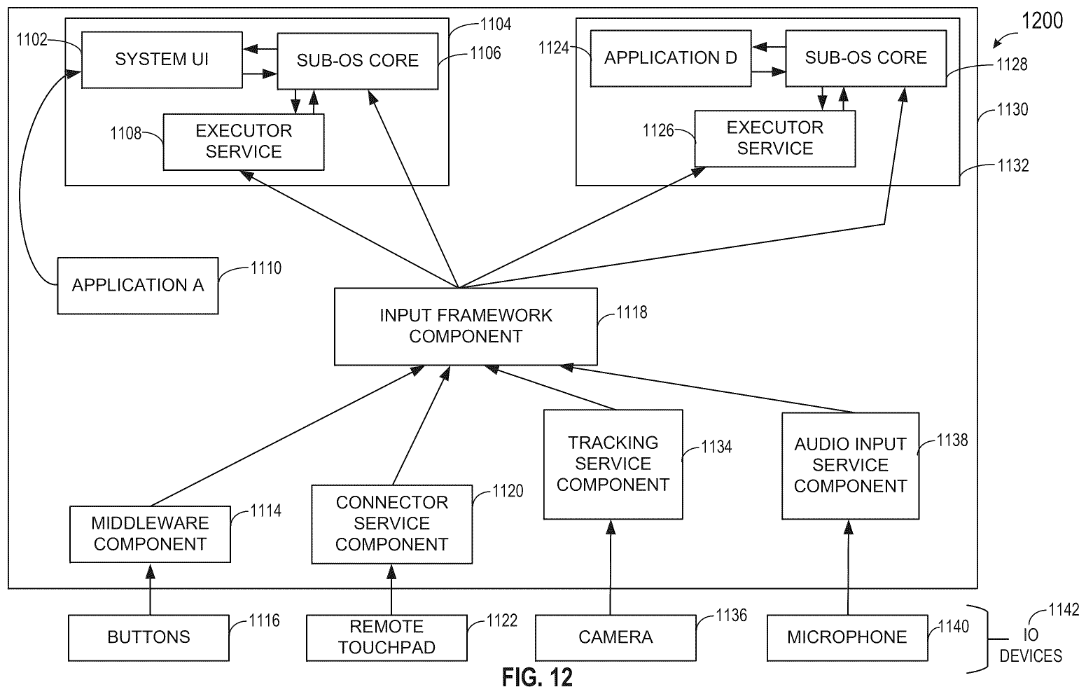

FIG. 12 illustrates a system 1200 for routing inputs on an XR wearable device, in accordance with some examples. The input data (arrows) is routed from the IO devices 1142 through the input framework component 1118. This input routing enables permissions for each type of component such as, referring to FIG. 9, sub-OS application 912, OS application 924, sub-OS core 910, and so forth. In some examples, the permissions enable better security. For example, when the user 958 is entering a password, input data generated from keyboard may be restricted to one component.

Additionally, the input framework component 1118 may pause input data for components such as application A 1110, which may be paused. In some examples, the input data is buffered or discarded by the input frame component 1118. Additionally, the permissions are used by the component controlling the IO devices 1142 to indicate to the user 958 that the input device 1142 is currently unavailable. For example, the component controlling the IO device 1142 provides feedback such as visual or auditory feedback to the user 958 to indicate the IO device 1142 is currently not accepting input. The permissions may additionally be used to restrict the input data generated by IO device 1142. The input framework component 1118 may push the input data to the component, notify the component of the availability of the input data, or respond to queries regarding whether the input data is available.

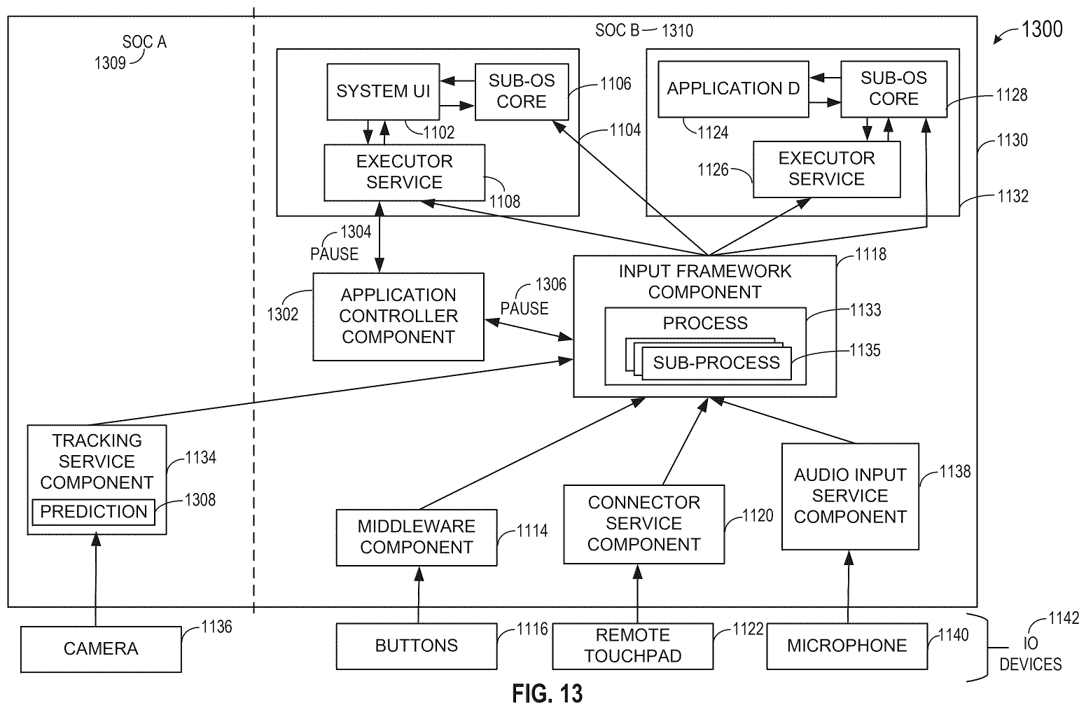

FIG. 13 illustrates a system 1300 for routing inputs on an XR wearable device, in accordance with some examples. The SoC A 1309 and SoC B 1310 are the same or similar as SoC 904. The OS 1130 may operate only on SoC B 1310 or be distributed between SoC A 1309 and SoC B 1310. In some examples, more than one SoC 904 is used due to the heavy processing load of some applications such as a tracking service component 1134. Data between SoC A 1309 and SoC B 1310 is transferred via the inter-SOC interface 905 of FIG. 9. Data that is transferred intra SoC 904 is transferred via intra-SoC interface 915 or intra-sub-OS interface 919.

The application controller component 1302 can control a pause 1304 indication from executor service 1108, which may be controlling or communicating with system UI 1102 or another sub-OS application 912 or OS application 914. The application controller component 1302 receives an indication that executor service 1108 is paused 1304. The application controller component 1302 indicates to the input framework component 1118 that executor service 1108 or another application is paused 1306. The input framework component 1118 then stops pushing input data to executor service 1108 and may buffer the input data.

The system 1300 supports applications that provide XR graphics. The tracking service component 1134 and/or the executor services 1108, 1126 performs predictions 1308 of where a real-world object such as user 958 will be so that XR objects do not appear to lag behind the real-world objects. The tracking service component 1134 and/or the executor services 1108, 1126 performs predictions 1308 based on a timestamp of when a frame will be rendered. For example, if a virtual pen is added to a hand of the user 958 the application generating the XR graphics for the virtual pen needs to predict where the hand of the user 958 will be so the virtual pen appears to remain stable in the hand of the user 958. The predictions 1308 are used to determine the location of where to render the XR graphics for the virtual object relative to the real-world object. The predictions 1308 are used to avoid the virtual objects from appearing to lag behind the moving object.

In some examples, the prediction 1308 from the tracking service component 1134 is delayed because it has to be transferred from the SOC A 1309 to the SOC B 1310 via the inter-SoC interface 905 and then the prediction 1308 is sent to the input framework component 1118, and then to the sub-OS core 1128 or the executor service 1126. The prediction 1308 may have to be transferred from the sub-OS core 1128 to the application D 1124 as well.

The tracking service component 1134 is on a different SoC 904 than the components that interact with the user 958 such as application D 1124 because of the high processing demands of the tracking service component 1134. One or more of the other IO devices 1142 and their respective components may be located on the SOC A 1309.

The latency from the inter-SoC interface 905, which may be termed inter process communication (IPC) calls, may cause a lag in rendering XR objects such as a virtual pen behind the, referring to FIG. 9, real-life position 966 of real-life objects such as the hand of the user 958.

In some examples, the input framework component 1118 is a collection of sub-processes 1135 running as children of a parent process 1133 and/or as part of a same component. Each IO device 1142 has a corresponding sub-process 1135. The process 1133 manages the priorities, permissions, and pausing of other processes and inputs. The middleware component 1114, connector service component 1120, and audio input service component 1138, as well as other components, can be processes 1133 within the input framework component 1118. The intra-process interface 925 is faster than the inter-SoC interface 905 and intra-Soc interface 915.

The system UI 1102 will trigger pause 1304 and the application controller component 1302 will then send a message to the input framework component 1118 to pause input for an application corresponding to the system UI 1102.

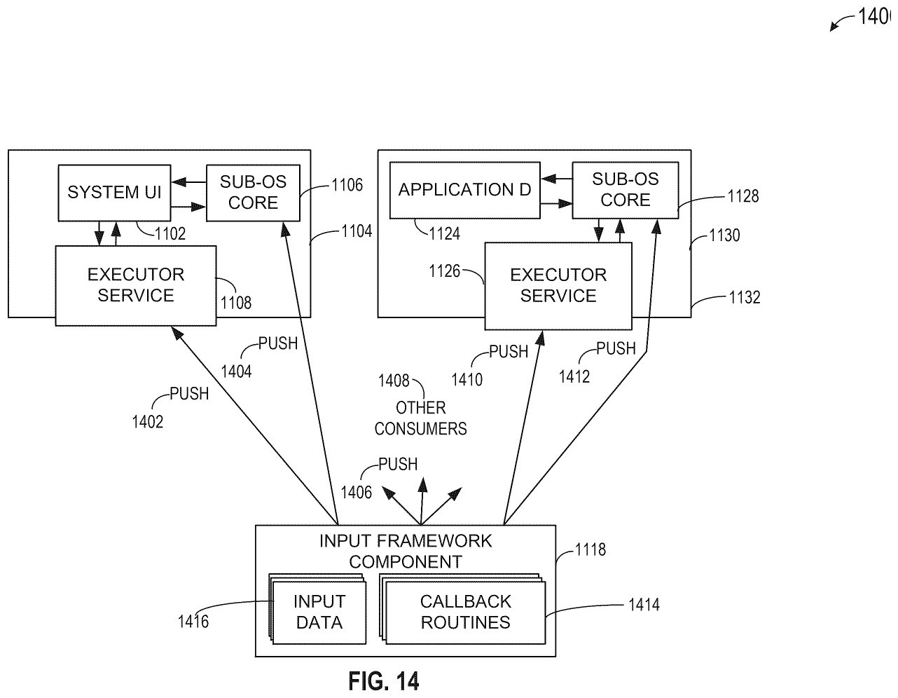

FIG. 14 illustrates a system 1400 for routing inputs on an XR wearable device, in accordance with some examples. In some examples, the input data is pulled by the applications that consume the input data. In some examples, the input data is pushed to the applications that consume the input data.

For applications written within the sub-OS 1104, 1132, a render loop drives by the processing. The executor service 1108, 1126, sub-OS core 1106, 1128, application D 1124, other consumers 1408, and/or system UI 1102 register callback routines 1414 with the input framework component 1118, which then uses the callback routines to push 1402, 1404, 1406, 1410, 1412, the input data 1416.

For example, input data 1416 from touchpad events, which is indicated to or transferred to the input framework component 1118 from the middleware component 1114, is pushed to the sub-OS core 1128 before a next processing/render cycle of the sub-OS core 1128 by the input framework component 1118 by calling a callback routine 1414 of the sub-OS core 1128. In some examples, the sub-OS core 1128, then pushes the input data 1416 to application D 1124 for consumption.

In some examples, the application D 1124 and other applications that are the same or similar as sub-OS application 912 of FIG. 9, may register a callback routine 1414 to receive the input data 1416 directly from the input framework component 1118. Some input data 1416 may need to be pre-processed.

In some examples, the executor service 1126 acts as a proxy for application D 1124 that registers a callback routine 1414 for input data 1416 for application D 1124, and then uses sub-OS 1132 calls to push the input data 1416 to application D 1124. Application D 1124 may be written in JavaScript® or Typescript and the calls between the executor service 1126 and application D 1124 may be slower at 130 us than intra-process calls. In some examples, sub-OS core 1106, 1128 determines the prediction 1308. Application D 1124 can either receive input data 1416 from the input framework component 1118 via the sub-OS core 1128 or via the executor service 1126.

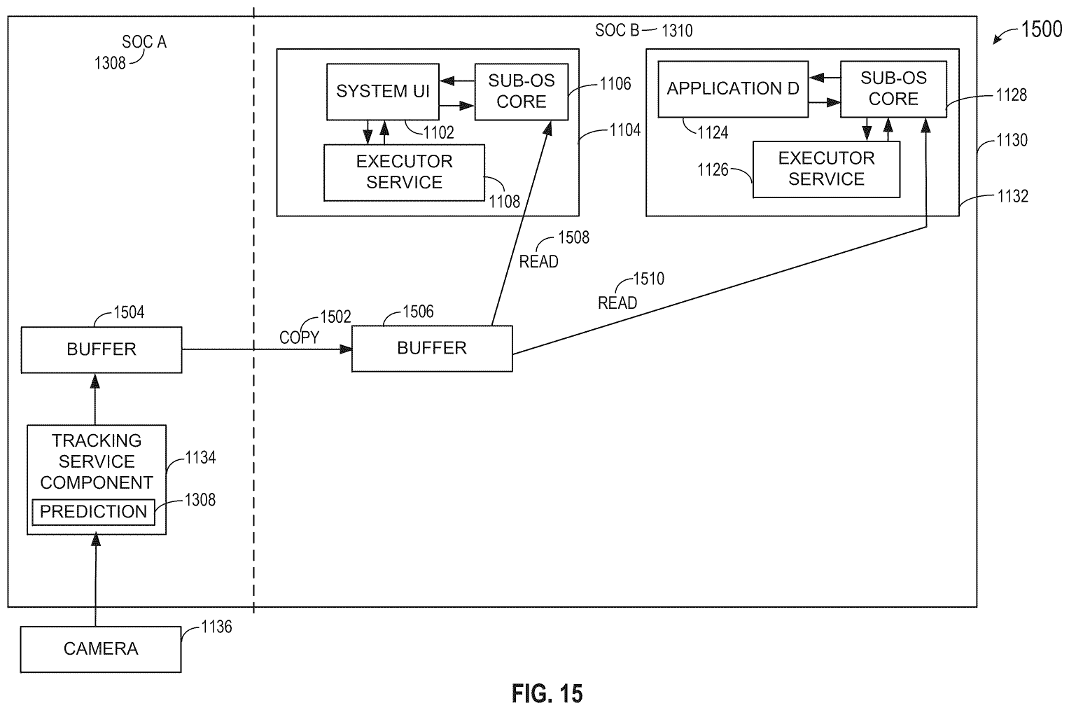

FIG. 15 illustrates a system 1500 for routing inputs on an XR wearable device, in accordance with some examples. The tracking service component 1134 tracks objects in the real-world scene 944 of FIG. 9 from the images 903 generated by the camera 1136. The processed images 903 and predictions 1308 are stored in the buffer 1504 and then transferred (copy 1502) via inter-SOC interface 905 to the buffer 1506. The sub-OS core 1106 and sub-OS core 1128 then read 1508, 1510, respectively, the buffer 1506. In some examples, only the inferring tracking data is transferred (copy 1502) via inter-SOC interface 905 to the buffer 1506.

In some examples, the input data and processed input data in the buffer 1506 is accessed from other components such as the application D 1124 or a process hosting a paused application D 1124. The copy 1502 incurs a larger latency than copies within a SoC.

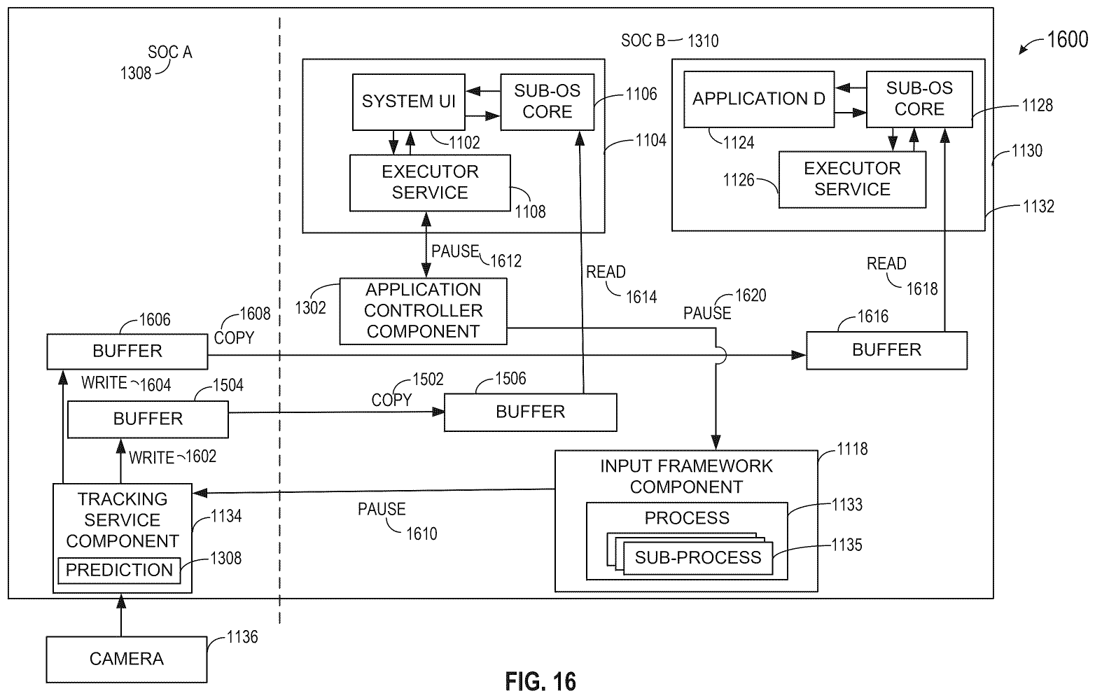

FIG. 16 illustrates a system 1600 for routing inputs on an XR wearable device, in accordance with some examples. The application controller component 1302 receives an indication of a pause 1612 or unpause from the executor service 1108 or another component of the sub-OS 1104. The paused component may be a sub-OS application 912 of the sub-OS 1104. The application controller component 1302 sends a message to pause 1620 or unpause to the input framework component 1118. The input framework component 1118 sends a message to pause 1610 or unpause to the tracking service component 1134 via inter-SOC interface 905. The tracking service component 1134 then pauses (or refrains from) or unpauses the copy 1502 to buffer 1506 of the prediction 1308 and/or input data. In some examples, a different component refrains from copying the prediction 1308 and/or the input data to the buffer 1506 when or if the sub-OS application 912 is paused. In this way, the buffer 1506 may be safe from being read by another component of the sub-OS 1104, and the predication 1308 and/or input data can be buffered so that the paused component of the sub-OS 1104 may access the prediction 1308 and/or input data when the component is unpaused. A buffer 1506, 1616, is opened for each sub-OS core 1106, 1128, respectively. In some examples, the tracking service component 1134 includes an application programming interface (API) that the input framework component 1118 uses to send the pause 1610, which may include an identification (ID) that indicates the buffer 1506, 1616. The tracking service component 1134 writes 1604 the input data and prediction 1308 to the buffer 1606 and writes 1602 the input data and prediction 1308 to buffer 1504. The sub-OS core 1106 is notified of the new input data or loops to check for the new input data and then reads 1614 the new input data from the buffer 1506. The sub-OS core 1128 is notified of the new input data or loops to check for the new input data and then reads 1618 the new input data from the buffer 1616.

In some examples, little to no latency is added because no additional processing is added between the tracking service component 1134 and the sub-OS 1104. The copy 1608, 1502 is performed twice which includes a slower inter-SOC interface 905.

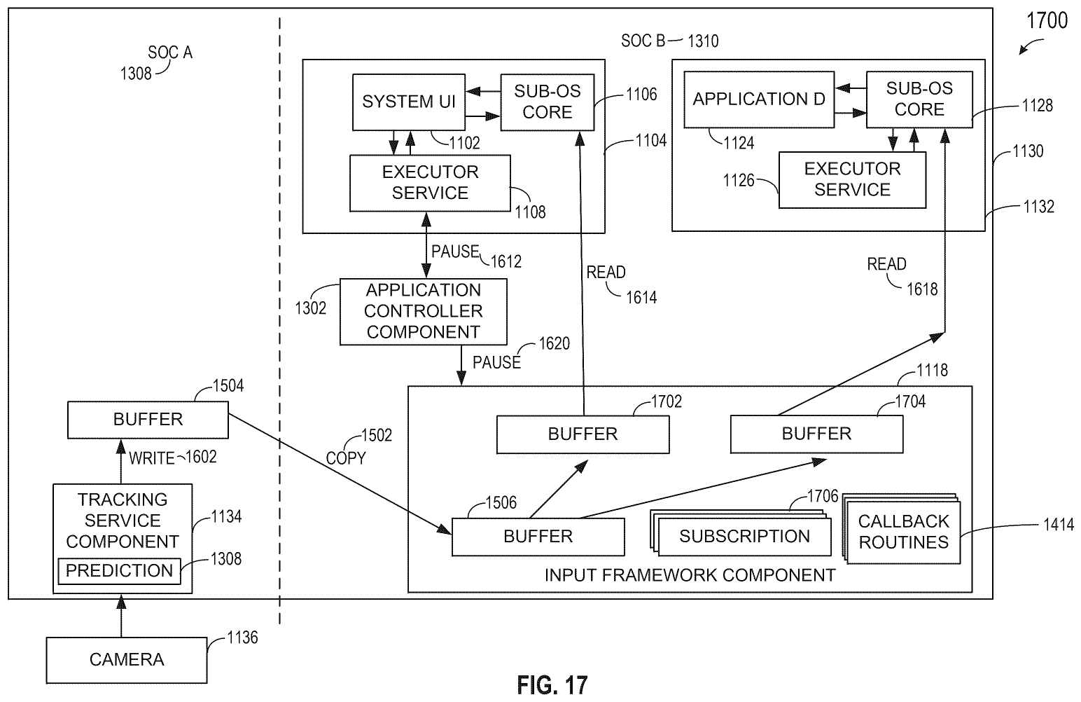

FIG. 17 illustrates a system 1700 for routing inputs on an XR wearable device, in accordance with some examples. The input framework component 1118 receives the prediction 1308 and/or input data from the buffer 1504 via an inter-SOC interface 905. The input framework component 1118 then copies the buffer 1506 to each buffer 1702, 1704 that has been opened for a sub-OS core 1106, 1128, respectively. The sub-OS cores 1106, 1128 subscribe via a message (not illustrated) to the input framework component 1118. The Input framework component 1118 creates a subscription 1706, which may include checks on whether the sub-OS core 1106, 1128 has permission to access the data requested. The buffer 1702, 1704 is created for the sub-OS core 1106, 1128, respectively. The input framework component 1118 only copies data from the buffer 1506 to the other buffers 1702, 1704, in accordance with the subscriptions 1706.

The input frame component 1118 may call a callback function provided by the sub-OS core 1106, 1128 or a component of the sub-OS core 1106, 1128. The input framework component 1118 receives the data from the buffer 1504, deserializes the data, inspects the data, copies the data into the other buffers 1702, 1704, and then notifies the subscribers in accordance with the subscriptions 1706 using the callback routines 1414. In some examples, data serialization over the inter-Soc interface 905 takes approximately twice as long as deserialization with extra overhead for copying to the other buffers 1702, 1704 and to call the callback routines 1414. When a component of the sub-OS core 1106 is paused 1612, the application controller component 1302 notifies the input frame component 1118, which then stops notifying the paused component of the data being available and may buffer the input data.

The format of the events sent by the tracking service component 1134 is an internal sub-OS 1104, 1132 format for serialized tracking updates. In some examples, the format for input data is a generic event that can represent any inputs with a set of identifiers, codes, modifiers, and a buffer for more complex data. In some examples, different structures are used for each event type, where event types include a physical keyboard key is pressed, an image has been captured, a remote touchpad has been touched, and so forth. The callback routines 1414 may either be specific for each type of event where the sub-OS core 1128 or another component registers for a specific type of event or the callback routines 1414 may be more generic such as registering for a class of input events and then the information regarding which event occurred is included in a data structure that is communicated to the sub-OS core 1128 or another component via the callback routine 1414. In some examples, delegates or specialized components translate the data structures from the inter-SOC interface 905 to a format for the sub-OS core 1128 or another component.

FIG. 18 illustrates a method 1800 for routing inputs on an XR wearable device, in accordance with some examples. The method 1800 begins at operation A 1812 with a client component 1804 sending, to input framework service 1832, a request for keyboard input with a callback routine 1839. The client component 1804 may be, referring to FIG. 9, an OS application 924, sub-OS application 914, sub-OS component 908, or another component of the XR wearable device 902. Referring to the interface example below, the operation A 1812 may correspond to “Input Framework Service,” in some examples. The input framework service 1832, keyboard input service 1822, and access control service 1814 are services provided by the input framework component 1118. The access control service 1814, input framework service 1832, keyboard input service 1822, and other input services 1828 may all be part of a same process of the input frame component 1118, which enables the calls between the services to be performed with an intra-process communication 1830, which is faster than inter-SOC interface 905 communication and intra-SOC interface 915 communication. The input services 1828 are services for other types of input such as joysticks, touchpads, and so forth.

In some examples, an input service 1828 may, referring to FIGS. 15 and 17, control the buffer 1506, buffer 1702, buffer 1704, and the subscriptions 1706 in a similar or same way as keyboard input service 1822 controls the input from a keyboard. The input framework service 1832 keeps a list of the subscriptions 1831 to input services 1828, which includes keyboard input service 1822, in accordance with some examples. This enables the input framework service 1832 to disable access to one or more input services 1828 in response to a request for input. The request for the input modality may include a flag for exclusive use. For example, the client component 1804 may request an input modality of text with exclusive access. The input framework service 1832 then determines by examining subscriptions 1831 other components that are using the input modality of text and disables them by sending messages to the keyboard input service 1822 to disable or remove the callback routines of the other components.

The method 1800 continues at operation B 1816 where the input framework service 1832 sends a message to a permission manager component 1802 to determine if the client component 1804 has permission for the requested input modality. The input framework service 1832 verifies that the client component 1804 has permission to access the input data 1833. The method 1800 continues at operation C 1820 with the input framework service 1832 registering the callback routine 1839 of the client component 1804 with the keyboard input service 1822.

The method 1800 continues at operation D 1824 with the connector service component 1837 reporting new keyboard input to the keyboard input service 1822. The method 1800 continues at operation E 1810 with the keyboard input service 1822 invoking the callback routine 1839 with the input data 1833. In some examples, the keyboard input service 1822 may pre-process the input data 1833. For example, for voice input, an input service may transcribe the voice input before calling the callback routine 1839.

In some examples, the callback routine 1839 has predefined data structures for the input data 1833 to be sent to the client component 1804. In some examples, a pointer to the input data 1833 is provided for the client component 1804 to access the input data 1833. The copying of the input data 1833 and sending it back to the client component 1804 provides greater security since the client component 1804 may be provided by a third-party and thus may not be secure. The security is provided by the input framework component 1118 and permission manager component 1802. In some examples, the input data 1833, referring to FIGS. 14-17, are the buffers 1506, 1616, 1702, 1704, the input data 1416, and so forth. In some examples, the input framework component 1118 or another component grants the client component 1804 access to a portion of the memory of the XR wearable device 902 storing the input data 1833 and then suspends the access to the portion of the memory when the client component 1804 no longer has access to the input data 1833. In some examples, security is provided by no longer copying the input data 1833 to the buffer storing the input data 1833 for an application. Controlling access to the memory is a security method that may forgo the need to copy the input data 1833. The input data 1833 can be copied using the callback routine 1839, which provides security, but when the input data 1833 is large such as for the camera 1136, a pointer to the input data 1833 is used with access to the portion of the memory containing the input data 1833 being restricted by, for example, services provided by, referring to FIG. 9, the OS 906 or sub-OS component 908.

The method 1800 continues at operation F 1808 with a privileged component 1806 calling an access control service 1814 indicating that keyboard access should be paused for the client component 1804. Referring to FIG. 9, the privileged component 1806 is a sub-OS core 910, OS application 914, OS application 924, or another component of the OS 906 with privileges to modify the input modalities of other components. In some examples, the privileged component 1806 pauses or restricts access to one or more IO devices 1142 of FIG. 13. For example, if a client component 1804 is performing a password input, then the privileged component 1806 may pause or restrict all access to the keyboard input service 1822 except by the client component 1804. Additionally, if operation A 1812 indicates that the input modality needs to be exclusive and the input framework service 1832 will then check with the permission manager component 1802 if the client component 1804 is permitted to have exclusive access to the keyboard input service 1822. If the client component 1804 is permitted exclusive access to the keyboard input service 1822, then the input framework service 1832 will perform calls to the keyboard input service 1822 to suspend or cancel other callback routines.

The method 1800 continues at operation G 1818 with the access control service 1814 sending a message or calling a routine that indicates to the keyboard input service 1822 that the input from the keyboard should be paused for the client component 1804. The access control service 1814 may be part of the input framework component 1118.

The method 1800 continues at operation H 1826 with additional input from the keyboard being sent to the keyboard input service 1822. The keyboard input service 1822 rather than calling the callback routine 1839 may buffer or discard the input from the keyboard.

In some examples, one or more of access control service 1814, input framework service 1832, input services 1828, and keyboard input service 1822 are turned into a separate process from the input framework component 1118. Making one or more of the services a separate process slows the communication between the services, intra-SOC interface 915 rather than intra-process communication 1830, but provides more resources for the service made into a separate process. For example, if one or more input service 1828 is being heavily used the process load of the input framework component 1118 may transgress or exceed a threshold. The input framework component 1118 or another component such as the OS 1130 may spawn an input service 1828 off into a new process, which may be in response to the process load exceeding or transgressing a threshold process load. For example, the keyboard input service 1822 may be its own process or may share a process with one or more additional input services 1828. In some examples, an input service 1828 manages the buffers 1506, 1702, 1704, as described in conjunction with FIG. 17. In some examples, an input service 1828 manages the buffers 1506, 1616 as described in conjunction with FIG. 16.

In some examples, the connector service component 1837 is an IO device 1142 of FIG. 13 or an intermediary between the IO device 1142 and the input service 1828. The connector service component 1837 may be the same or similar as the connector service component 1120 of FIG. 11. The connector service component 1837 may be a service that handles BLE traffic and provides the input data 1833 to the keyboard input service 1822. Intermediary processing may be performed on the input data 1833. For example, a voice transcription component may process voice data from the microphone and provide a transcription of the voice data. The operation A 1812 may request input data having a type transcription data. In some examples, the raw input data 1833 is handled by a different input service 1828 than input services 1828 that handle processed or pre-processed input data 1833 such as the transcript data. For example, the client component 1804 may request input data 1833 having the type transcription data of voice data. The input framework service 1832 may determine that the microphone input service 1828 needs to be activated to receive raw voice data and then activate an input service 1828 that processes the raw voice data into a transcription. The client service 1828 that provides the transcript would then have the callback routine 1839 and may process the raw data in a number of ways, including sending the raw data to a service for transcription. The client component 1804 then does not need to know how the transcription is produced.

In some examples, the client component 1804 is the sub-OS core 910 of FIG. 9 and the sub-OS core 910 acts as an intermediary between the keyboard input service 1822 and another component such as the application D 1124, which may be written within the context of the sub-OS 1132. The keyboard input service 1822 may communicate directly with the client component 1804, in accordance with some examples.

The following application program interface (API) in Java® may be used. Each component such as application D 1124 or sub-OS core 1128 registers with the input framework component 1118 using the following example data structure.

Interface IInputFrameworkService: IBase {IFHandle? registerClient( )}. The resulting “IFHandle” object represents the connection between the component and the input framework component 1118 and serves as the API for the component, which is the result of a request to register for an input modality. The result can contain additional information needed for the specific modality, for example a shared pointer to a buffer 1704 for Hand Tracking data.

struct ModalityRequestResult {
// oneof { .. buffer }
// or via pointers.};

A handle for connection with the input framework component 1118 allows the component holding the handle to request functionality from the input framework component 1118.

interface IFHandle : IBase {
// Returns the unique id assigned to this client connection.
string getId( );

The following enables the component to close the connection with the input framework component 1118.
void unregister( )

The following enables the component to check if the input framework component 1118 is active.
void heartbeat( )

The following enables the component to register for events where a null is returned to the component from the input network component 1118 if the registration was a failure and an object with additional data is returned if the registration was a success.

ModalityRequestResult*requestModality (Modality modality, IEventCallback? eventCallback);};

The modality can be either an enum or a simple type (int or string).

The IEventCallback interface hierarchy allows for receiving different types of events. The component provides an implementation of the callback to handle new events. The relevant methods in each callback will be executed by the input framework component 1118 for all the components registered for a given modality. The order of notifying components may vary or be based on a priority.

The following are callbacks examples for data. The base interface is empty.

```
    interface IEventCallback : IBase {
  // ...however, even the base interface could have things like
  // void onPause( ) oneway;
  // void onResume( ) oneway;
  // to notify the client of access change (see below).
};
interface ITouchpadEventCallback : IEventCallback {
  // NOTE: all of the callback methods are oneway.
  void onTouch(Some coordinates, AndOther data) oneway;
  void onSwipe(...) oneway;
};
interface IKeyboardEventCallback : IEventCallback {
void onKeyPress(int key, int modifier) oneway;
};
```

In some examples, there is a common parent interface for the event providers to inherit from such as event sources.

interface IInputEventProvider : IBase {
// Allows for a router to register. The router is an interface
// implementation specific to the modality that the provider offers,
// but the actual router entity is always going to be the
// Input Framework (IF).
IInputEventProviderSubscription? subscribe(IEventRouter? router);
};
// Represents a ‘handle’ for a live subscription between IF and the
// event provider.
interface IInputEventProviderSubscription : IBase {
// The router can call this method to end the connection.
void unsubscribe( ) oneway;
// A child of this interface can contain methods for passing events
// to the Input Event Provider. For example, for the Mobile Input
// Controller we need to inform the data provider of a successful
// calibration:
// void calibrationSuccessful( ) oneway;
};
interface IInputEventRouter : IBase {
// Empty. Each modality will have its own child interface exposing
// methods for notifying the Input Framework of new events. For
// example, for the Mobile Input Controller we have:
// void publishEvent(PoseEvent poseEvent) oneway;
};

For each modality, there is a child interface of IInputEventRouter which exposes methods that allow the provider to publish new events through the input framework component 1118. The provider exposes a service implementing the relevant interface such as IEventProvider or a child of it if new functionality is necessary. The input framework component 1118 registers with known providers for every modality it supports. Example providers include, referring to FIG. 13, middleware component 1114, connector service component 1120, audio input service component 1138, and tracking service component 1134.

The provider down casts the provided IEventClient pointer to the expected interface type. After a successful registration with the input framework component 1118, the provider notifies the input framework component 1118 of new events via the relevant methods of the IEventClient child interface.

For some modalities, calling OS 1130 methods to notify the component of a new event may be slower. For those cases, the client interface can expose methods that return a pointer to a shared buffer that the provider can then use to write data to.

The IEventProviderHandle can have child interfaces, which add more functionality. This enables the input framework component 1118 to send information back to the provider. For example, the input framework component 1118 sends back a notification to the provider mobile input controller (not illustrated) once the input framework component 1118 successfully finishes the controller calibration. The input framework component 1118 down casts the IEventProvider handle pointer to the appropriate interface for a given modality, and calls unregister( ).

In some examples, the input framework component 1118 controls which components have access to different input modalities. For example, the input framework component 1118 may call a permission manager component 1802 to determine the privileges of a component for an input modality. In some examples, the input framework component 1118 calls the permission manager component 1802 on each requestModality call from a component.

In some examples, the permission manager component 1802 has an API associated with it that enables other components to change the permissions of components for input modalities. For example, the sub-OS core 1128 may have access to the permission manager component 1802 to change permissions for input modalities.

An example, of revoking access for an input modality, is the sub-OS core 1106 pausing or unpausing a component such as application D 1124 and then revoking access to input modalities for application D 1124.

struct ClientInfo {
string clientId;
// appId may be used instead
// there is support for receiving it via intra-process calls
// string appId;
};
interface IInputFrameworkAccessController {
// True if access [was already] paused. False otherwise.
bool pauseAccessFor(ClientInfo clientInfo, Modality modality);
bool resumeAccessFor(ClientInfo clientInfo, Modality modality);
};

In some examples, the clientId is used as the identifier of the component for which to remove access. The component has to expose its id to the component that can control its access to the input modalities. The preceding is an example of an API to implement the functionalities described in conjunction with FIG. 18.

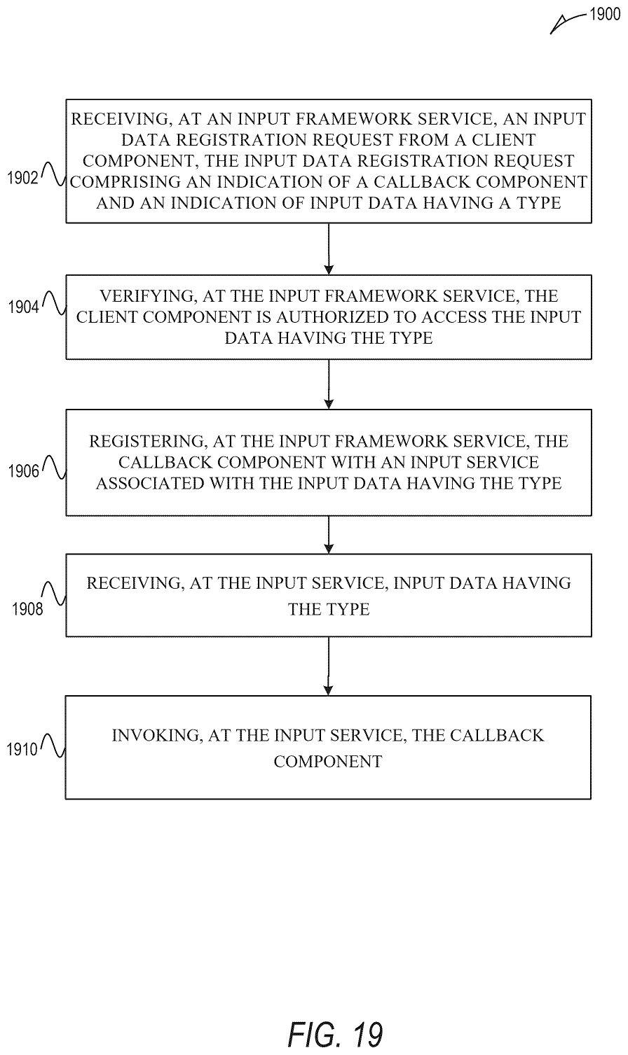

FIG. 19 illustrates a method 1900 for routing inputs on an XR wearable device, in accordance with some examples. The method 1900 begins at operation 1902 with receiving, at an input framework service, an input data registration request from a client component, the input data registration request comprising an indication of a callback component and an indication of input data having a type. For example, client component 1804 at operation A 1812 sends an input data registration request to the input framework service 1832 with an indication of input data 1833 and with a callback routine 1839.

The method 1900 continues at operation 1904 with verifying, at the input framework service, the client component is authorized to access the input data having the type. For example, the input framework service 1832 verifies at operation B 1816 that client component 1804 has the permissions to receive input data 1833.

The method 1900 continues at operation 1906 with registering, at the input framework service, the callback component with an input service associated with the input data having the type. For example, the input framework service 1832 registers the callback routine 1839 with the keyboard input service 1822.

The method 1900 continues at operation 1908 with receiving, at the input service, input data having the type. For example, the keyboard input service 1822 receives input data 1833 from the connector service component 1837. The method continues at operation 1910 with invoking, at the input service, the callback component. For example, the keyboard input service 1822 invokes callback routine 1839, which enables the client component 1804 to access the input data 1833.

One or more of the operations of method 1900 can be optional. For example, operation 1910 can be optional. Method 1900 can include one or more additional operations. The operations of method 1900 can be performed in a different order. Method 1900 may be performed by the XR wearable device 902 or an apparatus of the XR wearable device 902.

### Example Statements

Example 1 is an apparatus of a system comprising: at least one processor; at least one memory component storing instructions that, when executed by the at least one processor, cause the at least one processor to perform operations comprising: receiving, at an input framework service, an input data registration request from a client component, the input data registration request comprising an indication of a callback component and an indication of input data having a type; verifying, at the input framework service, the client component is authorized to access the input data having the type; registering, at the input framework service, the callback component with an input service associated with the input data having the type; receiving, at the input service, input data having the type; and invoking, at the input service, the callback component.

In Example 2, the subject matter of Example 1 includes, wherein the operations further comprise: receiving an indication that the client component is paused; and sending, to the input service, an indication to the input service that the client component is paused.

In Example 3, the subject matter of Example 2 includes, wherein the input data having the type is first input data having the type, wherein the operations further comprise: receiving, at the input service, second input data having the type; and storing the second input data having the type.

In Example 4, the subject matter of Example 3 includes, wherein the operations further comprise: receiving, at the input service, an indication that client component is unpaused; and invoking, at the input service, the callback component with an indication of the second input data having the type.

In Example 5, the subject matter of any of Examples 1˜4 includes, wherein the input data having the type is received from an input or output device associated with the system.

In Example 6, the subject matter of any of Examples 1-5 includes, wherein the input framework service is performed by a process and the input service is performed by a sub-process of the process.

In Example 7, the subject matter of Example 6 includes, wherein the registering the callback component with the input service is performed with an intra-process call.

In Example 8, the subject matter of any of Examples 6-7 includes, wherein the process is a first process, and wherein the operations further comprise: in response to a load of process transgressing a threshold, spawning the sub-process into a second process.

In Example 9, the subject matter of Example 8 includes, wherein the registering the callback component with the input service is performed with an inter process call.

In Example 10, the subject matter of any of Examples 1-9 includes, wherein the input data registration request is a first input data registration request, the callback component is a first callback component, wherein the input data having the type is input data of a first type, the input service is a first input service, and wherein the operations further comprise: receiving, at the input framework service, a second input data registration request from the client component, the second input data registration request comprising an indication of a second callback component and an indication of input data of a second type; verifying, at the input framework service, the client component is authorized to access the input data of the second type; and registering, at the input framework service, the second callback component with a second input service associated with the input data of the second type.

In Example 11, the subject matter of Example 10 includes, wherein the operations further comprise: receiving, via an inter system on a chip interface by the second input service, input data of the second type; and invoking, at the second input service, the second callback component.

In Example 12, the subject matter of any of Examples 10-11 includes, wherein the client component is a first client component and wherein the operations further comprise: receiving, at the input framework service, a third input data registration request from a second client component, the third input data registration request comprising an indication of a third callback component and an indication of input data of a second type; verifying, at the input framework service, the second client component is authorized to access the input data of the second type; and registering, at the input framework service, the third callback component with the second input service associated with the input data of the second type.

In Example 13, the subject matter of Example 12 includes, wherein the operations further comprise: receiving, via an inter system on a chip interface by the second input service, input data of the second type; copying the input data of the second type to a first buffer and to a second buffer; invoking, at the second input service, the second callback component with an indication of the first buffer; and invoking, at the second input service, the third callback component with an indication of the second buffer.

In Example 14, the subject matter of any of Examples 1-13 includes, wherein the client component is a core of an interpreter running on an operating system, and wherein the input framework service is a process of the operating system.

Example 15 is a non-transitory computer-readable storage medium storing instructions that, when executed by at least one processor of an apparatus of a system, cause the at least one processor to perform operations comprising: receiving, at an input framework service, an input data registration request from a client component, the input data registration request comprising an indication of a callback component and an indication of input data having a type; verifying, at the input framework service, the client component is authorized to access the input data having the type; registering, at the input framework service, the callback component with an input service associated with the input data having the type; receiving, at the input service, input data having the type; and invoking, at the input service, the callback component.

In Example 16, the subject matter of Example 15 includes, wherein the operations further comprise: receiving an indication that the client component is paused; and sending, to the input service, an indication to the input service that the client component is paused.

In Example 17, the subject matter of Example 16 includes, wherein the input data having the type is first input data having the type, wherein the operations further comprise: receiving, at the input service, second input data having the type; and storing the second input data having the type.

Example 18 is a method comprising: receiving, at an input framework service, an input data registration request from a client component, the input data registration request comprising an indication of a callback component and an indication of input data having a type; verifying, at the input framework service, the client component is authorized to access the input data having the type; registering, at the input framework service, the callback component with an input service associated with the input data having the type; receiving, at the input service, input data having the type; and invoking, at the input service, the callback component.

In Example 19, the subject matter of Example 18 includes, receiving an indication that the client component is paused; and sending, to the input service, an indication to the input service that the client component is paused.

In Example 20, the subject matter of Example 19 includes, wherein the input data having the type is first input data having the type, wherein the method further comprises: receiving, at the input service, second input data having the type; and storing the second input data having the type.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, network attached storage (NAS), storage area networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5GTM network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. An apparatus of an extended reality (XR) wearable device, the apparatus comprising:
at least one processor;
at least one memory component storing instructions that, when executed by the at least one processor, cause the at least one processor to perform operations comprising:
receiving, at an input framework service, an input data registration request from a client component, the input data registration request comprising an indication of a callback component and an indication of input data having a type;
verifying, at the input framework service, the client component is authorized to access the input data having the type;
registering, at the input framework service, the callback component with an input service associated with the input data having the type;
receiving, at the input service, input data having the type; and
invoking, at the input service, the callback component.

2. The apparatus of claim 1, wherein the operations further comprise:
receiving an indication that the client component is paused; and
sending, to the input service, an indication to the input service that the client component is paused.

3. The apparatus of claim 2, wherein the input data having the type is first input data having the type, wherein the operations further comprise:
receiving, at the input service, second input data having the type;
refraining invoking, at the input service, the callback component; and
storing the second input data having the type.

4. The apparatus of claim 3, wherein the operations further comprise:
receiving, at the input service, an indication that client component is unpaused; and
invoking, at the input service, the callback component with an indication of the second input data having the type.

5. The apparatus of claim 1, wherein the input data having the type is received from an input or output device associated with the XR wearable device.

6. The apparatus of claim 1, wherein the input framework service is performed by a process and the input service is performed by a sub-process of the process.

7. The apparatus of claim 6, wherein the registering the callback component with the input service is performed with an intra-process call.

8. The apparatus of claim 6, wherein the process is a first process, and wherein the operations further comprise:
in response to a load of process transgressing a threshold, spawning the sub-process into a second process.

9. The apparatus of claim 8, wherein the registering the callback component with the input service is performed with an inter process call.

10. The apparatus of claim 1, wherein the input data registration request is a first input data registration request, the callback component is a first callback component, wherein the input data having the type is input data of a first type, the input service is a first input service, and wherein the operations further comprise:
receiving, at the input framework service, a second input data registration request from the client component, the second input data registration request comprising an indication of a second callback component and an indication of input data of a second type;
verifying, at the input framework service, the client component is authorized to access the input data of the second type; and
registering, at the input framework service, the second callback component with a second input service associated with the input data of the second type.

11. The apparatus of claim 10, wherein the operations further comprise:
receiving, via an inter system on a chip interface by the second input service, input data of the second type; and
invoking, at the second input service, the second callback component.

12. The apparatus of claim 10, wherein the client component is a first client component and wherein the operations further comprise:
receiving, at the input framework service, a third input data registration request from a second client component, the third input data registration request comprising an indication of a third callback component and an indication of input data of a second type;
verifying, at the input framework service, the second client component is authorized to access the input data of the second type; and
registering, at the input framework service, the third callback component with the second input service associated with the input data of the second type.

13. The apparatus of claim 12, wherein the operations further comprise:
receiving, via an inter system on a chip interface by the second input service, input data of the second type;
copying the input data of the second type to a first buffer and to a second buffer;
invoking, at the second input service, the second callback component with an indication of the first buffer; and
invoking, at the second input service, the third callback component with an indication of the second buffer.

14. The apparatus of claim 1, wherein the client component is a core of an interpreter running on an operating system, and wherein the input framework service is a process of the operating system.

15. A non-transitory computer-readable storage medium storing instructions that, when executed by at least one processor of an apparatus of an extended reality (XR) wearable device, cause the at least one processor to perform operations comprising:
receiving, at an input framework service, an input data registration request from a client component, the input data registration request comprising an indication of a callback component and an indication of input data having a type;
verifying, at the input framework service, the client component is authorized to access the input data having the type;
registering, at the input framework service, the callback component with an input service associated with the input data having the type;
receiving, at the input service, input data having the type; and
invoking, at the input service, the callback component.

16. The non-transitory computer-readable storage medium of claim 15, wherein the operations further comprise:
receiving an indication that the client component is paused; and
sending, to the input service, an indication to the input service that the client component is paused.

17. The non-transitory computer-readable storage medium of claim 16, wherein the input data having the type is first input data having the type, wherein the operations further comprise:
receiving, at the input service, second input data having the type; and
storing the second input data having the type.

18. A method performed on an apparatus of an extended reality (XR) wearable device, the method comprising:
receiving, at an input framework service, an input data registration request from a client component, the input data registration request comprising an indication of a callback component and an indication of input data having a type;
verifying, at the input framework service, the client component is authorized to access the input data having the type;
registering, at the input framework service, the callback component with an input service associated with the input data having the type;
receiving, at the input service, input data having the type; and
invoking, at the input service, the callback component.

19. The method of claim 18, further comprising:
receiving an indication that the client component is paused; and
sending, to the input service, an indication to the input service that the client component is paused.

20. The method of claim 19, wherein the input data having the type is first input data having the type, wherein the method further comprises:
receiving, at the input service, second input data having the type; and
storing the second input data having the type.
